(19) United States
(12) Patent Application Publication
(10) Pub. No.: US 2013/0170388 A1
(43) Pub. Date: Jul. 4, 2013

(54) COMMUNICATION APPARATUS AND DELAY DETECTING METHOD

(71) Applicants: Teruaki Ito, Chiyoda-ku (JP); Tomoyuki Fujita, Chiyoda-ku (JP); Yasuto Kanayama, Nagoya-shi (JP)

(72) Inventors: Teruaki Ito, Chiyoda-ku (JP); Tomoyuki Fujita, Chiyoda-ku (JP); Yasuto Kanayama, Nagoya-shi (JP)

(73) Assignee: MITSUBISHI ELECTRIC CORPORATION, Chiyoda-ku, Tokyo (JP)

(21) Appl. No.: 13/821,733

(22) PCT Filed: Sep. 15, 2010
(86) PCT No.: PCT/JP2010/065986

§ 371 Date: Mar. 8, 2013

(51) Int. Cl. H04L 12/26

(52) U.S. Cl. CPC H04L 43/0858
USPC 370/252

(57) ABSTRACT

A communication apparatus includes a time-stamp generating unit for generating a time stamp during transmission or reception of a PDU transmitted and received, a transmission-data storing unit, a reception-data storing unit, a frame processing unit configured to generate a PDU including a data refresh instruction to the other node, periodical transmission data in the transmission-data storing unit, and a frame transmission time acquired from the time-stamp generating unit and store, upon receiving a PDU from the other node, periodical transmission data included in the PDU in the reception-data storing unit, and a one-way-delay detecting unit for determining, upon receiving the PDU, according to whether a next PDU has been received within a first delay allowable time after the last PDU was received, or whether a transmission time of the PDU is within a second delay allowable time, presence or absence of occurrence of a delay of a PDU.

### FIELD

The present invention relates to a communication apparatus and a delay detecting method.

### BACKGROUND

When communication is performed on a network, in particular, a network used in an FA (Factory Automation) system and required to have real-time properties, it is desired that a communication delay is within a predetermined time and, at the same time, there is no loss of information.

In general, for measurement of a delay, there are a method of measuring a delay time in a round trip between two nodes to be measured and a method of measuring a delay time in one way between the nodes. In the measurement of a delay time in one way, a delay can be determined at a point when a reception side receives a communication frame. Therefore, compared with the method of measuring the round-trip delay time, there is an advantage that a time required for the measurement of a delay can be reduced. On the other hand, to perform the measurement of a delay time in one way, clocks need to be synchronized between the nodes or an offset time of clocks needs to be calculated between the nodes.

The measurement of a delay time in one way is performed in Patent Literature 1 as explained below. First, an offset time of clocks is calculated. Subsequently, a node on a transmission side gives a time stamp of a transmission time to a packet to be transmitted and transmits the packet. Thereafter, a node on a reception side records a time stamp of a reception time of the packet. The node on the reception side calculates a delay using the offset time of the clocks between the nodes, the time stamp of the transmission time, and the time stamp of the reception time.

The calculation of an offset time of clocks is performed as explained below. It is assumed that the nodes have a time calculating function. First, a first node transmits, to a second node, a packet for shift time calculation to which a time stamp of a transmission time acquired from a clock of the first node is given. Subsequently, the second node adds, to the received packet, a packet reception time from the first node and a transmission time in returning a packet to the first node and returns the packet to the first node. The first node records a reception time of the returned packet and calculates a shift time based on these four times.

On the other hand, the clock synchronization between the two nodes is performed in Patent Literature 2 as explained below. First, a first node creates a measurement packet in which a transmission time is put in a first payload and transmits the measurement packet to a second node. Subsequently, when the second node receives the measurement packet from the first node, the second node creates a return packet in which a transmission time of the measurement packet is put in a first payload, a reception time of the measurement packet is put in a second payload, and a transmission time of the return packet is put in a third payload and transmits the return packet to the first node. The first node that receives the return packet records a reception time of the return packet and performs correction of a clock based on these four times.

Concerning a loss of information (a packet), for example, in Patent Literature 1, a packet loss ratio calculating function is provided in a node, a sequence number is given to a transmission packet, and the number of losses of packets is counted according to missing of the sequence number.

### CITATION LIST

### Patent Literature

Patent Literature 1: Japanese Patent Application Laid-Open No. 2004-289748
Patent Literature 2: Japanese Patent Application Laid-Open No. 2007-27985

### SUMMARY

### Technical Problem

However, in the method of calculating an offset time described in Patent Literature 1, the packet for offset time calculation is transmitted and received in parallel to a packet used for normal communication. When such a method is applied to a node that performs a periodical operation such as an incorporated system, it is necessary to irregularly (at different periods) perform transmission and reception processing of the packet for offset time calculation. Therefore, there is a problem in that it is difficult to maintain the periodical operation.

In the clock synchronization method described in Patent Literature 2, because it is necessary to put three kinds of time information in the payload of the return packet, a data size of the time information is made large. Therefore, in a situation in which a payload size is limited, there is a problem in that a region for carrying normal data is spoiled.

Further, in the detection of a delay, all times used for the delay detection are stored in a packet. Therefore, there is also a problem in that time information stored in the packet is made large. A loss of packets is detected according to missing of the sequence number. However, for example, when one packet is transmitted, there is also a problem in that it is difficult to detect a loss.

The present invention has been devised in view of the above and it is an object of the present invention to obtain, in a communication system in which nodes that perform a periodical operation are connected by a network, a communication apparatus and a delay detecting method that can maintain the periodical operation and transmit information for calculating a shift of clocks between the nodes without putting pressure on a region for storing normal data.

### Solution to Problem

In order to solve the aforementioned problems, a communication apparatus that performs periodical communication with another communication apparatus connected via a transmission line according to one aspect of the present invention is constructed in such a manner as to include: a clock configured to measure time; a communicating unit configured to transmit and receive a communication frame; a time-stamp generating unit configured to generate a time stamp using the clock during transmission or during reception of the communication frame transmitted and received by the own communication apparatus; a transmission-data storing unit configured to store periodical transmission data stored in the periodically-transmitted communication frame; a reception-data storing unit configured to store the periodical transmission data in the periodically-received communication frame; a frame processing unit configured to generate a refresh instruction frame including a data refresh instruction to the other communication apparatus, the periodical transmission data in the transmission-data storing unit, and a frame transmission time, which is a time stamp of transmission timing, acquired from the time-stamp generating unit and store, upon receiving a refresh instruction frame from the other communication apparatus, periodical transmission data included in the refresh instruction frame in the reception-data storing unit; and a one-way-delay detecting unit configured to determine, upon receiving the refresh instruction frame, whether a next refresh instruction frame is received within a first delay allowable time after the refresh instruction frame is received last time and determine, when the next refresh instruction frame is received within the first delay allowable time, according to whether a transmission time of the refresh instruction frame from the other communication apparatus to the own apparatus is within a second delay allowable time, whether a delay has occurred in a communication frame transmitted from the other communication apparatus.

### Advantageous Effects of Invention

According to the present invention, a time stamp used for detection of a delay is stored in a communication frame exchanged between two nodes during periodical communication in addition to data to be transmitted. A delay of the communication frame in a network is detected from the time stamp stored in the communication frame to be periodically communicated and a reception time of the communication frame. Consequently, it is unnecessary to transmit a new communication frame to detect a delay besides the communication frame exchanged during the periodical communication. Time information included in the communication frame has to be only a transmission time of the communication frame. The size of the communication frame does not change. Therefore, when the present invention is applied to an apparatus that operates at a predetermined processing period such as a programmable controller that performs sequence control, there is an effect that it is possible to perform delay detection for a communication frame without affecting regular data processing.

### BRIEF DESCRIPTION OF DRAWINGS

FIG. 1 is a schematic diagram of an example of a network to which a communication system according to a first embodiment of the present invention is applied.

FIG. 2 is a schematic diagram of an example of the configuration of a PDU.

FIG. 3 is a schematic diagram of the configuration of communication nodes included in a communication system.

FIG. 4 is a sequence chart for explaining exchange of a PDU in clock offset calculation processing between a master station and a slave station before the start of periodical communication.

FIG. 5 is a sequence chart for explaining exchange of a PDU in the clock offset calculation processing between the master station and the slave station during the periodical communication.

FIG. 6 is a flowchart for explaining an example of an operation processing procedure during clock offset calculation of the master station.

FIG. 7 is a flowchart for explaining an example of an operation processing procedure during clock offset calculation of the slave station.

FIG. 8 is a flowchart for explaining an example of a procedure of one-way delay detection processing according to the first embodiment.

FIG. 9 is a flowchart for explaining an example of a procedure of round-trip delay detection processing in the master station according to the first embodiment.

FIG. 10 is a flowchart for explaining an example of a procedure of PDU loss detection processing according to the first embodiment.

FIG. 11 is a flowchart for explaining an example of a procedure of check code setting processing during PDU transmission of a slave station according to a second embodiment.

FIG. 12 is a flowchart for explaining an example of a procedure of one-way delay detection processing according to the second embodiment.

FIG. 13 is a flowchart for explaining an example of a procedure of generation processing for a 48-bit PDU transmission time and a 48-bit PDU reception time by a master station.

FIG. 14 is a flowchart for explaining an example of a procedure of generation processing for a 48-bit PDU transmission time and a 48-bit PDU reception time by the slave station.

FIG. 15 is a flowchart for explaining an example of a procedure of loss detection processing according to the second embodiment.

FIG. 16 is a flowchart for explaining an example of a procedure of generation processing for a 48-bit PDU transmission time and a 48-bit PDU reception time by the master station.

FIG. 17 is a flowchart for explaining an example of a procedure of generation processing for a 48-bit PDU transmission time and a 48-bit PDU reception time by the slave station.

### DESCRIPTION OF EMBODIMENTS

Preferred embodiments of a communication apparatus and a delay detecting method according to the present invention are explained in detail below with reference to the accompanying drawings. The present invention is not limited by the embodiments.

### First Embodiment

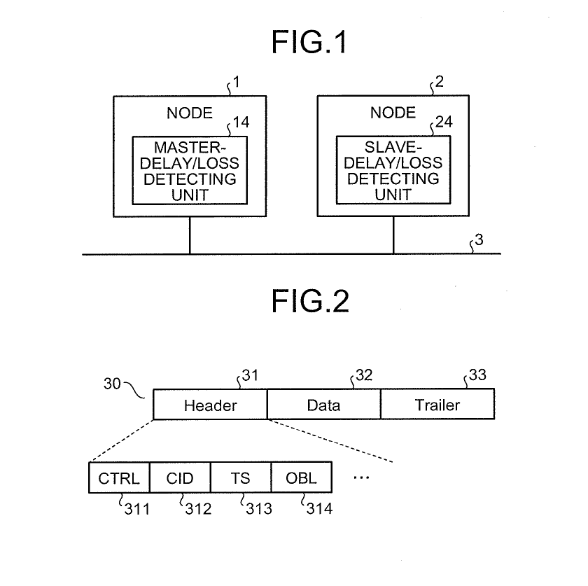

FIG. 1 is a schematic diagram of an example of a network to which a communication system according to a first embodiment of the present invention is applied. As shown in the figure, the communication system includes a configuration in which two nodes 1 and 2 are connected via a transmission line 3 such as an Ethernet (registered trademark). The node 1 includes a master-delay/loss detecting unit 14 having a function of, for example, instructing the node 2 to calculate a clock offset. The node 2 includes a slave-delay/loss detecting unit 24 that performs, for example, processing for calculating a clock offset according to an instruction from the master-delay/loss detecting unit 14 of the node 1.

In the first embodiment, communication is performed between a pair of the nodes 1 and 2 including the master-delay/loss detecting unit 14 and the slave-delay/loss detecting unit determined in advance. Specifically, the node 1 has a function of instructing, when periodical communication is performed, the node 2 to be paired with the node 1 to measure and calculate a clock offset at a predetermined period. The node 2 has a function of performing measurement for calculating a clock offset and calculation of the clock offset according to the instruction from the node 1 to be paired with the node 2. The master-delay/loss detecting unit 14 of the node 1 and the slave-delay/loss detecting unit 24 of the node 2 also have a function of detecting a delay and a loss of a communication frame during periodical communication using a communication frame used in the periodical communication.

In the following explanation, the node 1 that instructs calculation of a clock offset is referred to as master station and the node 2 that performs calculation processing for a clock offset based on an instruction from the master station 1 is referred to as slave station.

In the example shown in FIG. 1, the two nodes 1 and 2 are connected to the network. However, three or more nodes can be connected to the network. One node can include a plurality of delay/loss detecting units and perform communication with a plurality of nodes including delay/loss detecting units to be paired with the respective delay/loss detecting units. For example, the first node (the master station) 1 can include first and second master-delay/loss detecting unit, the first master-delay/loss detecting unit forms a pair with a slave-delay/loss detecting unit of the second node (the slave station) 2, and the second master-delay/loss detecting unit can form a pair with a slave-delay/loss detecting unit of a third node (a slave station) to perform communication.

The configuration of a protocol data unit (hereinafter referred to as PDU) stored in a data section of a communication frame exchanged in the communication system is explained. FIG. 2 is a schematic diagram of an example of the configuration of the PDU. A PDU 30 includes a header section (Header) 31, a data section (Data) 32, and a trailer section (Trailer) 33.

The header section 31 has header information of the PDU 30 and includes CTRL 311, CID 312, TS 313, and OBL 314. The CTRL 311 includes type information representing a type of the PDU 30, request/response information including a bit representing request/response, and PDU association information including a bit representing association of the PDU used for offset calculation.

As types of the PDU 30, in the first embodiment, four types are used, i.e., RefreshReady for performing notification of preparation completion of refresh processing and offset measurement, RefreshMO for performing notification of the refresh processing and the offset measurement, RefreshGO for performing notification of the refresh processing and offset generation, and Refresh for performing notification of the refresh processing.

The request/response information is a bit for representing whether the PDU 30 represented by the type information is a request or a response to the request. The request and the response are determined to be in a bit-inverted relation.

The PDU association information is inverted from an initial state every time offset calculation is performed. The PDU association information is used for specifying a set of PDUs 30 used for offset calculation. Specifically, concerning the PDUs 30 of RefreshMO or RefreshReady (measurement instruction) and RefreshGO (calculation instruction) exchanged during one offset calculation processing, the PDU association information has the same bit (value). The PDUs 30 of RefreshMO and RefreshGO exchanged during next offset calculation processing are the PDUs 30 in which the previous PDU association information is inverted. For example, concerning a series of processing of a RefreshReady request issued from the master station 1, a RefreshReady response issued from the slave station 2, a RefreshGO request issued from the master station 1, and a RefreshGO response issued from the slave station 2, the PDU association information is the same bit (value), for example “0”. Concerning a series of processing of a RefreshMO request issued from the master station 1 next, a RefreshMO response issued from the slave station 2, a RefreshGO request issued from the master station 1, and a RefreshGO response issued from the salve station 2, the PDU association information is the same bit, i.e., “1”, different from the PDU association information of the last time. Further, concerning a series of processing of a RefreshMO request issued from the master station 1 next, a RefreshMO response issued from the slave station 2, a RefreshGO request issued from the master station 1, and a RefreshGO response issued from the slave station 2, the PDU association information is the same bit, i.e., “0”, different from the PDU association information of the last time. The PDU association information is set in this way.

The CID 312 is identification information for linking the master-delay/loss detecting unit 14 of the master station 1 and the slave-delay/loss detecting unit 24 of the slave stations 2, which are the pair that performs communication. The identification information stored in the CID 312 is different for each pair of the master-delay/loss detecting unit 14 and the slave-delay/loss detecting unit 24, which perform communication, and is generated to be unique in the network. As an example of a generation rule for the identification information stored in the CID 312, a method of connecting an address of the master station 1 and an address of the slave station 2 can be illustrated. However, when a second master-delay/loss detecting unit is provided in the master station 1, a second slave-delay/loss detecting unit is provided in the slave station 2, and second communication is performed between the master station 1 and the slave station 2 using the second master-delay/loss detecting unit and the second slave-delay/loss detecting unit as a second pair, redundancy occurs under the generation rule for the identification information. Therefore, as a generation rule for identification information used when the second pair performs communication, a method of inverting connection order in the identification information generation rule and connecting the address of the slave station 2 and the address of the master station 1 can be illustrated.

The TS 313 is a region in which a time stamp concerning transmission timing of the PDU 30 is stored. Specifically, during periodical communication, the master-delay/loss detecting unit 14 or the slave-delay/loss detecting unit 24 stores a time stamp of timing for transmitting the PDU 30 in the TS 313. In communication other than the periodical communication, a time stamp of timing when the PDU 30 representing a request is transmitted by the master-delay/loss detecting unit 14 is stored in the TS 313. When the PDU 30 representing a response to the request from the master-delay/loss detecting unit 14 is transmitted by the slave-delay/loss detecting unit 24, a value stored in the TS 313 of the PDU 30 representing a request corresponding to the response (i.e., a time stamp indicating transmission timing for the request corresponding to the response) is stored in the TS 313. Main types of the PDU 30 transmitted in the periodical communication are RefreshMO, RefreshGO, and Refresh.

The OBL 314 is a region in which information used in calculating an offset of a clock is stored. Specifically, when the type information of the CTRL 311 is RefreshGO and the request/response information is a request, i.e., when the PDU 30 is a RefreshGO request, a value of a time stamp indicating reception timing for a RefreshReady response or a RefreshMO response, which is a base for generating the RefreshGO request, is stored in the OBL 314.

The data section 32 is a data storage region for data and the like to be periodically communicated. The trailer section 33 is a storage region for a check code used in detecting breakage of the PDU 30. As the check code, a CRC (Cyclic Redundancy Check) cyclic redundancy code and the like can be used.

As explained above, the TS 313 stores a transmission time of the PDU 30 used for detection of a delay and a loss of the PDU 30 transmitted from the master station 1 to the slave station 2 or from the slave station 2 to the master station 1. However, in the first embodiment, in addition to the TS 313, the OBL 314 that stores a reception time of the PDU 30 in the master station 1 necessary for calculation of a clock offset is provided, whereby a configuration in which a clock offset based on the maser station 1 can be calculated on the slave station 2 side is obtained. Processing for detecting a delay and a loss and processing for calculating a clock offset using these kinds of information are explained below.

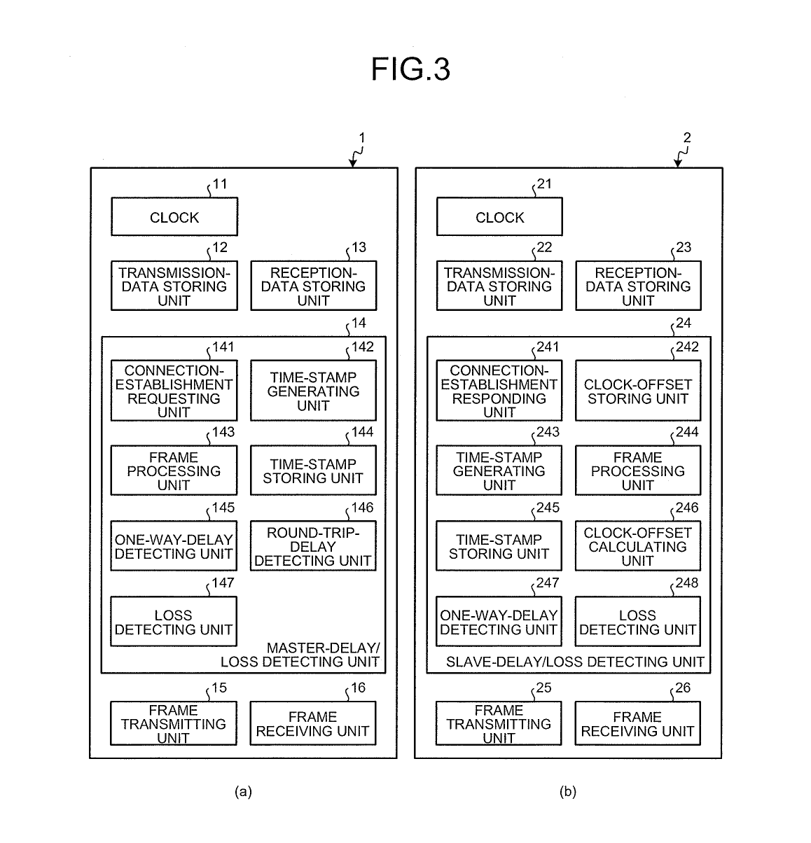

FIG. 3 is a schematic diagram of the configuration of communication nodes included in the communication system. FIG. 3(a) is a schematic block diagram of the configuration of the master station. FIG. 3(b) is a schematic block diagram of the configuration of the slave station.

As shown in FIG. 3(a), the master station 1 includes a clock 11, a transmission-data storing unit 12, a reception-data storing unit 13, the master-delay/loss detecting unit 14, a frame transmitting unit 15, and a frame receiving unit 16.

The clock 11 generates time information used by the master station 1. The transmission-data storing unit 12 stores, for example, periodical transmission data to be transmitted to another node in, the periodical communication. The reception-data storing unit 13 stores, for example, data stored in a data section of a PDU received in the periodical communication (periodical reception data). The periodical transmission data stored in the transmission-data storing unit 12 is used for calculation of a value set in a not-shown input and output apparatus or the like connected to another node (the slave station 2) performed by a not-shown processing apparatus connected to the own apparatus. The periodical reception data stored in the reception-data storing unit 13 is an output value or the like from the input and output apparatus connected to the other node and is used for calculation in the processing apparatus.

The master-delay/loss detecting unit 14 has a function of generating a PDU exchanged with a partner node (the slave station 2) and detecting a delay and a loss of the PDU using the PDU periodically communicated with the partner node. The master-delay/loss detecting unit 14 has a function of storing information necessary for calculation of a clock offset of the slave station 2 in the PDU and transmitting the PDU and instructing the slave station 2 to measure and calculate the clock offset.

The frame transmitting unit 15 stores the PDU generated by the master-delay/loss detecting unit 14 in a data section of a communication frame such as an Ethernet (registered trademark) frame and transmits the PDU to the network. The frame receiving unit 16 receives the communication frame addressed to the own node referring to a header of the communication frame such as an Ethernet (registered trademark) frame flowing on the network and extracts the PDU stored in the data section.

A more detailed configuration of the master-delay/loss detecting unit 14 is explained. The master-delay/loss detecting unit 14 includes a connection-establishment requesting unit 141, a time-stamp generating unit 142, a frame processing unit 143, a time-stamp storing unit 144, a one-way-delay detecting unit 145, a round-trip-delay detecting unit 146, and a loss detecting unit 147.

The connection-establishment requesting unit 141 performs connection establishment processing between the connection-establishment requesting unit 141 and the node to be paired (the slave station 2).

The time-stamp generating unit 142 generates a time stamp, which is a time of transmission, based on the clock 11 of a PDU transmitted (generated) by the frame processing unit 143 and passes the time stamp to the frame processing unit 143. The time-stamp generating unit 142 also generates a time stamp at a point when a PDU is received from another node.

The frame processing unit 143 has a function of generating a PDU to be transmitted to the slave station 2 according to a processing situation. For example, when the connection establishment processing is completed, the frame, processing unit 143 generates a RefreshReady request. When a RefreshReady response or a RefreshMO response is received and periodical transmission data is present in the transmission-data storing unit 12, the frame processing unit 143 generates a RefreshGO request. Further, when a RefreshGO response is received and periodical transmission data is present in the transmission-data storing unit 12, the frame processing unit 143 generates a RefreshMO request. In other cases during the periodical communication, the frame processing unit 143 generates a Refresh request.

In these cases, the frame processing unit 143 stores predetermined information in the storage regions, for example, stores, in the data section 32, periodical transmission data stored in the transmission-data storing unit 12 and stores, in TSs of PDUs, a time stamp passed from the time-stamp generating unit 142. When generating a RefreshGO request, the frame processing unit 143 stores, in the OBL, a time stamp at the reception time of a RefreshReady response or a RefreshMO response based on which the RefreshGO request is generated.

Further, the frame processing unit 143 also has a function of acquiring data stored in a data section of a received PDU and stores the data in the reception-data storing unit 13 or reads out a time stamp from a TS and stores the time stamp in the time-stamp storing unit 144 as a PDU transmission time to extract information necessary for the processing units.

The time-stamp storing unit 144 stores a value stored in a TS of a received PDU and a time stamp generated by the time-stamp generating unit when a predetermined PDU is received. For delay detection and clock offset calculation, the time-stamp storing unit 144 stores, as a PDU transmission time T_snd, a value stored in a TS of a received Refresh request, RefreshMO response, or RefreshGO response and stores, as a PDU reception time T_rcv, a time stamp generated by the time-stamp generating unit 142 at the reception time of the Refresh request, the RefreshMO response, or the RefreshGO response. For loss detection, the time-stamp storing unit 144 stores, as a last PDU transmission time T_psnd, a value stored in a TS of a RefreshReady response, a Refresh request, a RefreshMO response, or a RefreshGO response and stores, as a present PDU transmission time T_nsnd, a value stored in a TS of a Refresh request, a RefreshMO response, or a RefreshGO response received immediately after the PDU.

The one-way-delay detecting unit 145 detects occurrence of a delay of a PDU using the PDU received from the slave station 2. The one-way-delay detecting unit 145 performs delay determination according to whether the PDU is periodically received and time required for the PDU to reach the own node from the partner node. Specifically, the one-way-delay detecting unit 145 starts a timer simultaneously with the start of the periodical communication or at the reception time of the last PDU and determines that a delay exceeds an allowable delay when a Refresh request, a RefreshMO response, or a RefreshGO response is not received within a predetermined time (a first delay allowable time r_interval). Even when a Refresh request, a RefreshMO response, or a RefreshGO response is received within the predetermined time, the one-way-delay detecting unit 145 determines the exceeding of the allowable delay according to Formula (1) below using the PDU transmission time T_snd and the PDU reception time T_rcv in the time-stamp storing unit 144. A second delay allowable time is represented as d_allowed. When Formula (1) is satisfied, the one-way-delay detecting unit 145 determines that a delay has not occurred. When Formula (1) is not satisfied, the one-way-delay detecting unit 145 determines that a delay has occurred. The first delay allowable time r_interval and the second delay allowable time d_allowed can be set to the same value or can be set to different values.

T_{—}rcv−T_{—}snd<d_allowed (1)

The round-trip-delay detecting unit 146 detects whether a round-trip delay is within an allowable delay in a request response sequence between the master station 1 and the slave station 2. Specifically, the round-trip-delay detecting unit 146 starts a timer upon transmitting a request PDU in the request response sequence. The round-trip-delay detecting unit 146 determines that a delay exceeds an allowable delay when a response PDU to the request is not received within a predetermined time (a round-trip delay allowable time rtt_allowed). The request response sequence refers to processing in which, when a PDU indicating a request is transmitted to the slave station 2, a PDU indicating a response to the request is returned from the slave station 2. For example, a request response sequence before offset calculation, RefreshReady request and response, RefreshMO request and response, and RefreshGO request and response used in the offset calculation, and a request response sequence in communication other than the periodical communication can be illustrated. It is assumed that the round-trip delay detection processing by the round-trip-delay detecting unit 146 is performed when the periodical communication is not performed.

The round-trip-delay detecting unit 146 confirms that the received response PDU is a response PDU corresponding to the transmitted request PDU. Specifically, when the request PDU transmitted by the own node is a request PDU transmitted before offset calculation, a RefreshReady request, and a request PDU in communication other than the periodical communication, the round-trip-delay detecting unit 146 checks whether a TS of the transmitted request PDU and a TS of the received response PDU coincide with each other. When the request PDU transmitted by the own node is a RefreshMO request and the RefreshGO request, the round-trip-delay detecting unit 146 compares PDU association information in a CTRL of the transmitted request PDU and PDU association information in a CTRL of the response PDU received from the partner node and determines whether the pieces of the PDU association information coincide with each other. When the pieces of the PDU association information coincide with each other, the round-trip-delay detecting unit 146 confirms that the received request PDU is a response PDU corresponding to the transmitted request PDU.

The loss detecting unit 147 detects a loss of a PDU on the network. Specifically, the loss detecting unit 147 determines a loss of a PDU according to Formula (2) below using the last PDU transmission time T_psnd and the present PDU transmission time T_nsnd in the time-stamp storing unit. A loss evaluation time meaning an allowable reception interval is represented as trns_interval. When Formula (2) is satisfied, the loss detecting unit 147 determines that a loss has not occurred. When Formula (2) is not satisfied, the loss detecting unit 147 determines that a loss has occurred.

T_{—}psnd−T_{—}nsnd<trns_interval (2)

Upon determining that a loss has not occurred in the determination by Formula (2), the loss detecting unit 147 sets the value T_nsnd of the present PDU transmission time in the time-stamp storing unit 144 as a new last PDU transmission time T_psnd and performs processing for deleting the value of the present PDU transmission time. Consequently, it is possible to apply loss detection processing to a periodically-received Refresh request, RefreshMO response, or RefreshGO response.

As shown in FIG. 3(b), the slave station 2 includes clock 21, a transmission-data storing unit 22, a reception-data storing unit 23, the slave-delay/loss detecting unit 24, a frame transmitting unit 25, and a frame receiving unit 26. The clock 21, the transmission-data storing unit 22, the reception-data storing unit 23, the frame transmitting unit 25, and the frame receiving unit 26 have functions same as the functions of the corresponding units of the master station 1. Therefore, explanation of the units is omitted.

The slave-delay/loss detecting unit 24 has a function of generating a PDU to be exchanged between the slave station 2 and the master station 1 and detecting a delay and a loss of the PDU using the PDU to be periodically communicated. The slave-delay/loss detecting unit 24 also has a function of acquiring, from the PDU, information necessary for calculation of a clock offset from the partner node and calculating the clock offset. The slave-delay/loss detecting unit 24 having such functions includes a connection-establishment responding unit 241, a clock-offset storing unit 242, a time-stamp generating unit 243, a frame processing unit 244, a time-stamp storing unit 245, a clock-offset calculating unit 246, a one-way-delay detecting unit 247, and a loss detecting unit 248.

The connection-establishment responding unit 241 performs connection establishment processing between the slave station 2 and the master station 1 to be paired. The clock-offset storing unit 242 stores a clock offset, which is a value of a shift of the clock 21 of the slave station 2 based on the clock 11 of the master station 1.

The time-stamp generating unit 243 generates, concerning a PDU transmitted (generated) by the frame processing unit 244, a time stamp, which is a transmission time, based on the clock 11 of the master station 1 and passes the time stamp to the frame processing unit 244. The time-stamp generating unit 243 also generates a time stamp at a point when a PDU is received from another node. The time-stamp generating unit 243 generates a time stamp based on a sum of a time (a value) obtained from the clock 21 and the clock offset in the clock-offset storing unit 242.

The frame processing unit 244 has a function of generating, according to a processing situation, a PDU to be transmitted to the master station 1 to be paired. For example, when a RefreshReady request, a RefreshMO request, and a RefreshGO request are received and periodical transmission data is stored in the transmission-data storing unit 22, the frame processing unit 244 generates a RefreshReady response, a RefreshMO response, and a RefreshGO response. When the PDU is not received in the periodical communication and a predetermined time elapses from the last reception of the PDU, the frame processing unit 244 generates a Refresh request.

In these cases, the frame processing unit 244 stores predetermined information in the storage regions, for example, stores, in a data section of the PDU, the periodical transmission data stored in the transmission-data storing unit 22, stores, in a TS, the time stamp passed from the time-stamp generating unit 243 during the periodical communication, and stores, in a TS of a response PDU to the received PDU, a value stored in the TS of the received PDU in communication other than the periodical communication.

The frame processing unit 244 also has a function of acquiring data stored in a data section of the received PDU and storing the data in the reception-data storing unit 23 and reading out the time stamp from the TS and storing the time stamp in the time-stamp storing unit 245 as a PDU transmission time to extract information necessary for the processing units from the received PDU.

The time-stamp storing unit 245 stores a value stored in the TS of the received PDU and a time stamp generated by the time-stamp generating unit 243 when a PDU of a predetermined type is received. For delay detection, the time-stamp storing unit 245 stores, as the PDU transmission time T_snd, a value stored in a TS of a received Refresh request, RefreshMO request, or RefreshGO request and stores, as the PDU reception time T_rcv, a time stamp at the reception time of the Refresh request, the RefreshMO request, or the RefreshGO request. For loss detection, the time-stamp storing unit 245 stores, as the last PDU transmission time T_psnd, a value stored in a TS of a RefreshReady request, a Refresh request, a RefreshMO request, or a RefreshGO request and stores, as the present PDU transmission time T_nsnd, a value stored in a TS of a Refresh request, a RefreshMO request, or a RefreshGO request received immediately after the PDU.

Further, for clock offset calculation, the time-stamp storing unit 245 stores, as a PDU master transmission time for measurement Tm_snd, a value stored in a TS in a PDU including an offset measurement instruction received from the master station 1 and stores, as a PDU slave reception time for measurement Ts_rcv, a time stamp acquired from the time-stamp generating unit 243 when the PDU including the offset measurement instruction is received. The time-stamp storing unit 245 stores, as a PDU slave transmission time for measurement Ts_snd, a time stamp acquired from the time-stamp generating unit 243 when a response PDU corresponding to the PDU including the offset measurement instruction is transmitted. Further, the time-stamp storing unit 245 stores, as a PDU master reception time for measurement Tm_rcv, a value in an OBL of a PDU including an offset calculation instruction received from the master station 1. As the PDU including the offset measurement instruction, a RefreshReady request or a RefreshMO request can be illustrated. As the response PDU corresponding to the PDU including the offset measurement instruction, a RefreshReady response or a RefreshMO response can be illustrated. As the PDU including the offset calculation instruction, a RefreshGO request can be illustrated.

The clock-offset calculating unit 246 calculates an offset (a clock offset) between the clock 11 of the master station 1 and the clock 21 of the own node necessary in performing one-way delay measurement by a time stamp. Specifically, upon receiving the PDU including the offset calculation instruction, the clock-offset calculating unit 246 calculates a clock offset ts_offset using Formula (3) below from the PDU master transmission time for measurement Tm_snd, the PDU slave reception time for measurement Ts_rcv, the PDU slave transmission time for measurement Ts_snd, and the PDU master reception time for measurement Tm_rcv from the time-stamp storing unit 245.

ts_offset=[Tm_{—}rcv+Tm_{—}snd−(Ts_{—}rcv+Ts_{—}snd)]/2 (3)

The one-way-delay detecting unit 247 detects occurrence of a delay of a PDU using the PDU received from the master station 1. Specifically, the one-way-delay detecting unit 247 starts a timer simultaneously with the start of the periodical communication or at the last PDU reception time and determines that a delay exceeds an allowable delay when a Refresh request, a RefreshMO request, or a RefreshGO request is not received within the predetermined time (the first one-way delay allowable value r_interval). Even when a Refresh request, a RefreshMO request, or a RefreshGO request is received within the predetermined time, the one-way-delay detecting unit 247 determines the exceeding of the allowably delay using Formula (1) from the PDU transmission time T_snd and the PDU reception time T_rcv in the time-stamp storing unit 245.

The loss detecting unit 248 detects a loss of a PDU on the network. Specifically, the loss detecting unit 248 determines a loss of a PDU using Formula (2) from the last PDU transmission time T_psnd and the present PDU transmission time T_nsnd in the time-stamp storing unit 245.

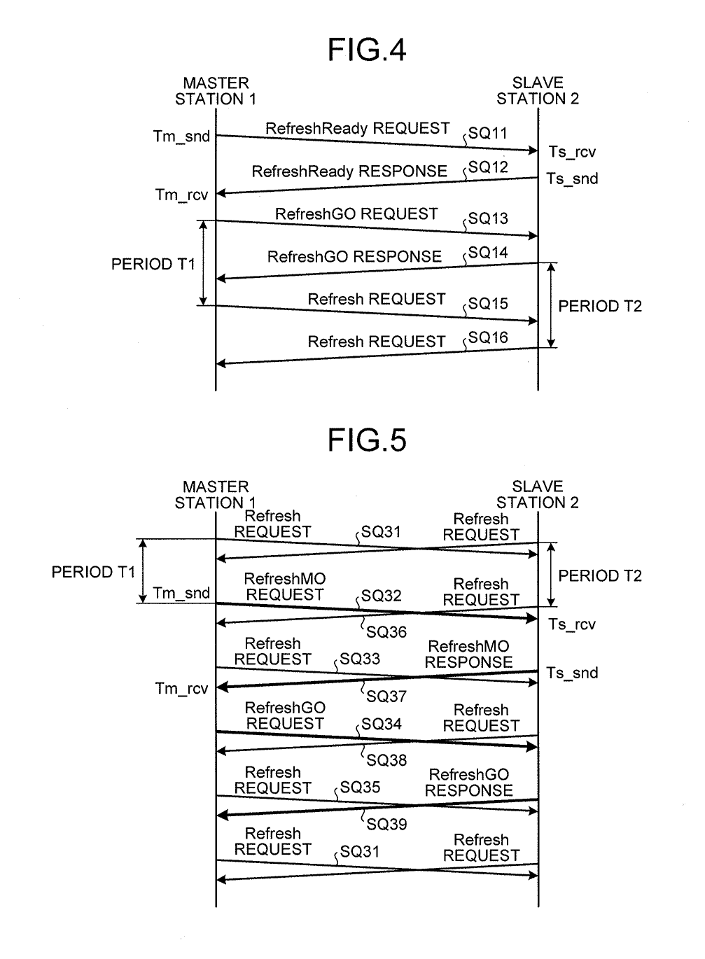

A clock offset calculating method, a one-way delay detecting method, a round-trip delay detecting method, and a loss detecting method in the communication system having such a configuration are explained below. First, the clock offset calculating method is explained. FIG. 4 is a sequence chart for explaining exchange of a PDU in clock offset calculation processing between the master station and the slave station before the start of the periodical communication. FIG. 5 is a sequence chart for explaining exchange of a PDU in the clock offset calculation processing between the master station and the slave station during the periodical communication.

As shown in FIG. 4, before the periodical communication start, a RefreshReady request including an offset measurement instruction and a refresh preparation completion notification are issued from the master station 1 to the slave station 2 (SQ11). A RefreshReady response, which is a response to the RefreshReady request, is issued from the slave station 2 (SQ12). A time stamp Tm_snd at the time when the RefreshReady request is issued from the master station 1, a time stamp Ts_rcv at the time when the RefreshReady request is received by the slave station 2, a time stamp Ts_snd at the time when the RefreshReady response is issued from the slave station 2, and a time stamp Tm_rcv at the time when the RefreshReady response is received by the master station 1 are generated by the time-stamp generating units of the respective nodes.

Subsequently, a RefreshGO request for instructing calculation of a clock offset is transmitted from the master station 1 (SQ13). Upon receiving the RefreshGO request, the slave station 2 starts calculation processing for a clock offset using the acquired time stamps Tm_snd, Ts_rcv, Ts_snd, and Tm_rcv. The reception of the RefreshGO request gives an opportunity for the periodical communication to be started in the slave station 2. The slave station 2 transmits a RefreshGO response, which is a response to the RefreshGO request (SQ14). The reception of the RefreshGO response gives an opportunity for the periodical communication to be started in the master station 1.

Thereafter, the master station 1 transmits a Refresh request after a predetermined time has elapsed (SQ15). The slave station 2 also transmits the Refresh request after the predetermined time has elapsed (SQ16). In the master station 1, time from the transmission of the RefreshGO request until the transmission of the next Refresh request is a period T1. In the slave station 2, time from the transmission of the RefreshGO response until the transmission of the next Refresh request is a period T2.

On the other hand, as shown in FIG. 5, during the periodical communication, requests and responses for instructing refresh processing are periodically issued from the master station 1 and the slave station 2 (SQ31 to SQ39). After the periodical communication is started, the master station 1 transmits, at a predetermined time interval, a RefreshMO request for instructing measurement of a clock offset and the refresh processing (SQ32). The slave station 2 transmits a RefreshMO response, which is a response to the RefreshMO request (SQ37). The time stamp Tm_snd at the time when the RefreshMO request is issued from the master station 1, the time stamp Ts_rcv at the time when the RefreshMO request is received by the slave station 2, the time stamp Ts_snd at the time when the RefreshMO response is issued from the slave station 2, and the time stamp Tm_rcv at the time when the RefreshMO response is received by the master station 1 are generated by the time-stamp generating units of the respective nodes.

Subsequently, a RefreshGO request for instructing calculation of a clock offset and the refresh processing is transmitted from the master station 1 (SQ34). Upon receiving the RefreshGO request, the slave station 2 performs calculation processing for a clock offset using the acquired time stamps Tm_snd, Ts_rcv, Ts_snd, and Tm_rcv and sets the calculated clock offset as a new clock offset. The salve station 2 transmits a RefreshGO response, which is a response to the RefreshGO request (SQ39).

As explained above, during the periodical communication, the Refresh requests are periodically transmitted by both of the master station 1 and the slave station 2. However, a measurement instruction and a calculation instruction for a clock offset and responses to the instructions are transmitted while being included in the Refresh requests rather than being transmitted at timing different from timing for the Refresh request.

In the master station 1, time from the transmission of the refresh instruction PDU including an instruction for the refresh processing such as a Refresh request, a RefreshGO request, or a RefreshMO request until the transmission of the next refresh instruction PDU is a period T1. Similarly, in the slave station 2, time from the transmission of the refresh instruction PDU (a Refresh request, a RefreshGO response, or a RefreshMO response) until the transmission of the next refresh instruction PDU is a period T2.

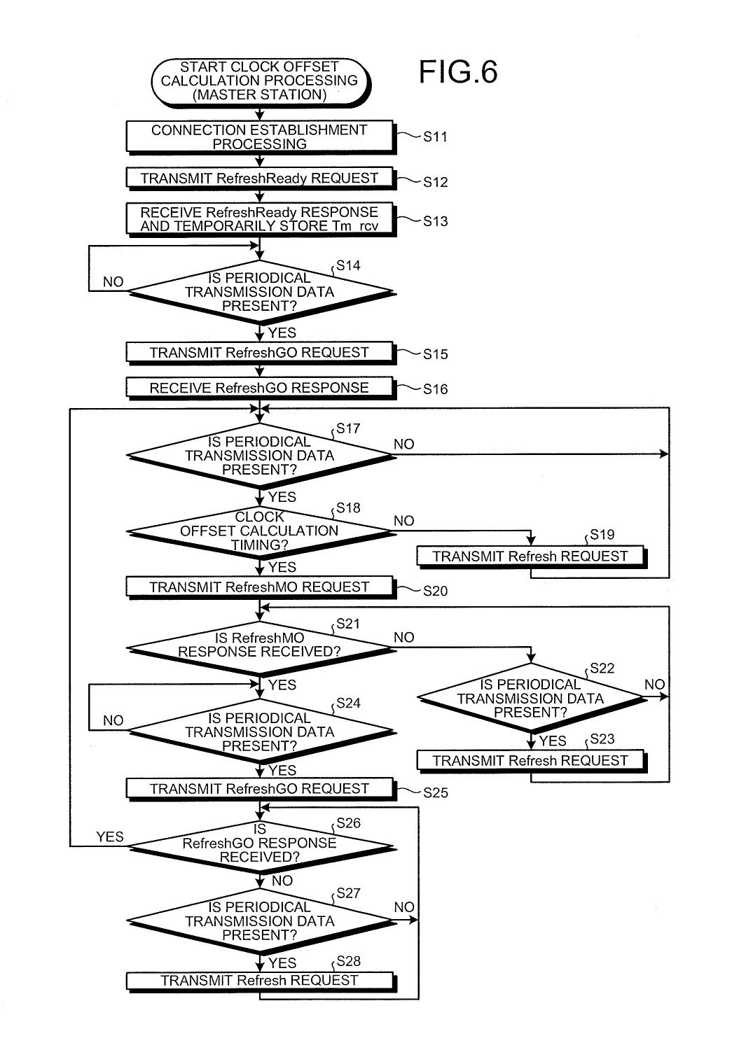

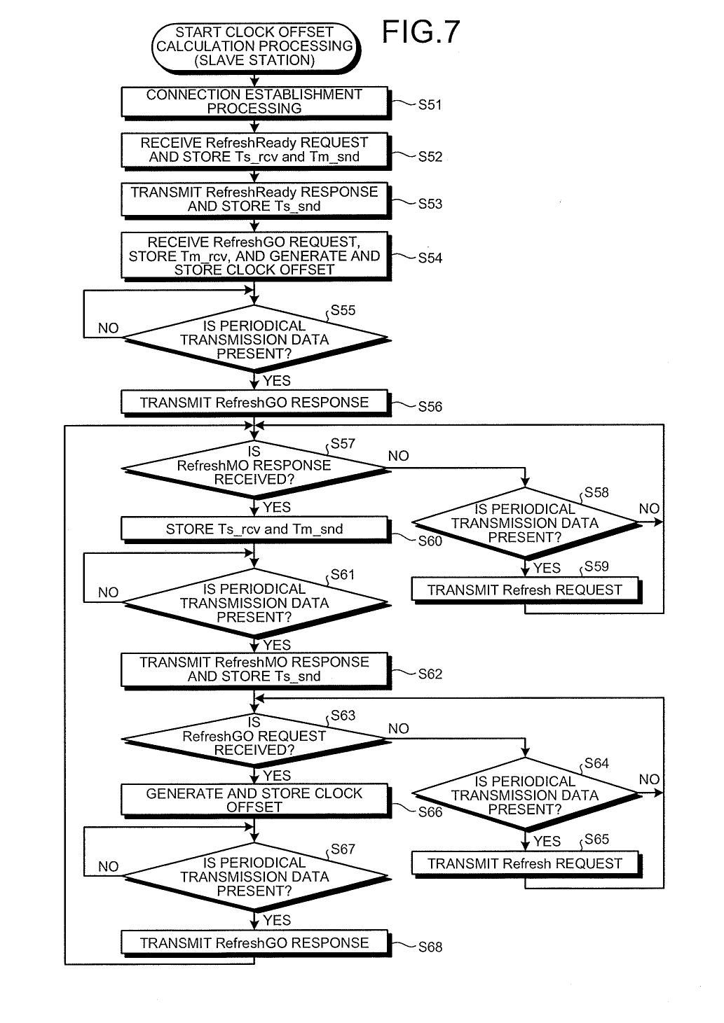

FIG. 6 is a flowchart for explaining an example of an operation processing procedure during clock offset calculation of the master station. FIG. 7 is a flowchart for explaining an example of an operation processing procedure during clock offset calculation of the slave station. The flowcharts include initialization processing and refresh processing in the master station 1 and the slave station 2. A flow of processing is explained alternately citing FIGS. 6 and 7 according to the flow of the processing.

First, the connection-establishment requesting unit 141 of the master station 1 and the connection-establishment responding unit 241 of the slave station 2 perform connection establishment processing between the master station 1 and the slave station 2 (step S11 in FIG. 6 and step S51 in FIG. 7). In the connection establishment processing, the connection-establishment requesting unit 141 of the master station 1 transmits a connection establishment request to the connection-establishment responding unit 241 of the slave station 2 and receives a response from the connection-establishment responding unit 241 of the slave station 2. Thereafter, the connection-establishment requesting unit 141 performs setting and confirmation of parameters necessary in the master-delay/loss detecting unit 14 and the slave-delay/loss detecting unit 24.

When the connection establishment processing is completed, as shown in FIG. 6, the frame processing unit 143 of the master station 1 receives a time stamp of transmission timing from the time-stamp generating unit 142 and generates a RefreshReady request for instructing the slave station 2 to measure a clock offset simultaneously with notifying the completion of preparation of refresh. At this point, the frame processing unit 143 stores the received time stamp in a TS of the RefreshReady request. The frame transmitting unit 15 transmits the generated RefreshReady request to the slave station 2 (step S12). This is equivalent to SQ11 in the sequence shown in FIG. 4 and is start timing for offset calculation.

Subsequently, as shown in FIG. 7, when the RefreshReady request is received by the frame receiving unit 26, the frame processing unit 244 of the slave station 2 receives a time stamp of reception timing from the time-stamp generating unit 243 and stores the received time stamp in the time-stamp storing unit 245 as the PDU slave reception time for measurement Ts_rcv. The frame processing unit 244 stores a value in a TS of the received RefreshReady request in the time-stamp storing unit 245 as the PDU master transmission time for measurement Tm_snd (step S52).

Thereafter, the frame processing unit 244 of the slave station 2 generates, as a response to the received RefreshReady request, a RefreshReady response in which a value stored in the TS of the RefreshReady request is stored in a TS. The frame processing unit 244 transmits the RefreshReady response from the frame transmitting unit 25. At this point, the frame processing unit 244 stores the time stamp received from the time-stamp generating unit 243 at the RefreshReady response transmission time in the time-stamp storing unit 245 as the EDU slave transmission time for measurement Ts_snd (step S53). This is equivalent to SQ12 in the sequence shown in FIG. 4.

Subsequently, as shown in FIG. 6, the frame receiving unit 16 of the master station 1 receives the RefreshReady response. The frame processing unit 143 receives a time stamp of reception timing from the time-stamp generating unit 142 and temporarily stores the time stamp (step S13). The frame processing unit 143 determines whether data to be transmitted in the periodical communication (hereinafter referred to as periodical transmission data) is present anew in the transmission-data storing unit 12 (step S14). When periodical transmission data is not stored (NO at step S14), the frame processing unit 143 stays in a waiting state until periodical transmission data is stored in the transmission-data storing unit 12. When periodical transmission data is stored (Yes at step S14), the frame processing unit 143 receives a time stamp of transmission timing from the time-stamp generating unit 142. The frame processing unit 143 creates a RefreshGO request in which the received time stamp is stored in a TS, the periodical transmission data is stored in a data section, and the time stamp of the reception timing for the RefreshReady response temporarily stored at step S13 is stored in an OBL. The frame processing unit 143 transmits the RefreshGO request from the frame transmitting unit 15 to the slave station 2 (step S15). This is equivalent to SQ13 in the sequence shown in FIG. 4.

Thereafter, as shown in FIG. 7, when the slave station 2 receives the RefreshGO request in the frame receiving unit 26, the frame processing unit 244 stores the time stamp stored in the OB of the RefreshGO request in the time-stamp storing unit 245 as the PDU master reception time for measurement Tm_rcv. Subsequently, because the RefreshGO request is received, the clock-offset calculating unit 246 calculates a clock offset of the clock 21 of the slave station 2 with respect to the clock 11 of the master station 1 using Formula (3) from Tm_snd, Ts_rcv, Ts_snd, and Tm_rcv stored in the time-stamp storing unit 245. The clock-offset calculating unit 246 stores a clock offset obtained by adding the calculated clock offset to a value of the clock offset stored in the clock-offset storing unit 242 so far in the clock-offset storing unit 242 as a new clock offset (step S54). It is assumed that a clock offset before communication is started is 0.

Thereafter, the frame processing unit 244 of the slave station 2 determines whether periodical transmission data is stored anew in the transmission-data storing unit 22 (step S55). When periodical transmission data is not stored (No at step S55), the frame processing unit 244 stays in a waiting state until periodical transmission data is stored in the transmission-data storing unit 22. When periodical transmission data is stored (Yes at step S55), the frame processing unit 244 receives a time stamp of transmission timing from the time-stamp generating unit 243, and creates a RefreshGO response in which the received time stamp is stored in a TS and the periodical transmission data is stored in a data section. The RefreshGO response is transmitted from the frame transmitting unit 25 to the master station 1 (step S56). This is equivalent to SQ14 in the sequence shown in FIG. 4.

Subsequently, as shown in FIG. 6, when the master station 1 receives the RefreshGO response in the frame receiving unit 16 (step S16), the frame processing unit 143 determines whether periodical transmission data is stored anew in the transmission-data storing unit 12 (step S17). When periodical transmission data is not stored anew (No at step S17), the frame processing unit 143 stays in a waiting state until transmission data is stored in the transmission-data storing unit 22. When periodical transmission data is stored anew (Yes at step S17), the frame processing unit 143 determines whether timing for clock offset calculation has come (step S18). Clock offset calculation is carried out at a predetermined time interval after first clock offset calculation is started at step S12. Therefore, the clock offset calculation is performed by determining, by performing measurement using the clock 11, whether a predetermined time has elapsed from the last clock offset calculation.

When the timing for clock offset calculation has not come (No at step S18), the frame processing unit 143 receives a time stamp of transmission timing from the time-stamp generating unit 142, creates a Refresh request in which the received time stamp is stored in a TS and the periodical transmission data is stored in a data section, and transmits the Refresh request from the frame transmitting unit 15 to the slave station 2 (step S19). This is equivalent to SQ15 in the sequence shown in FIG. 4 and SQ31 in the sequence shown in FIG. 5. The processing returns to step S17.

On the other hand, when it is determined at step S18 that the timing for clock offset calculation has come (Yes at step S18), the frame processing unit 143 receives a time stamp of transmission timing from the time-stamp generating unit 142, creates a RefreshMO request in which the received time stamp is stored in a TS and the periodical transmission data stored in the transmission-data storing unit 12 is stored in a data section, and transmits the RefreshMO request from the frame transmitting unit 15 to the slave station 2 (step S20). This is equivalent to SQ32 in the sequence shown in FIG. 5.

Subsequently, as shown in FIG. 7, the slave station 2 determines whether the RefreshMO request is received by the frame receiving unit 26 (step S57). When the RefreshMO request is not received (NO at step S57), the frame processing unit 244 further determines whether new periodical transmission data is stored in the transmission-data storing unit 22 (step S58). When periodical transmission data is not stored (No at step S58), the processing returns to step S57. When periodical transmission data is stored (Yes at step S58), the frame processing unit 244 receives a time stamp of transmission timing from the time-stamp generating unit 243, generates a Refresh request in which the received time stamp is stored in a TS and the periodical transmission data stored in the transmission-data storing unit 22 is stored in a data section, and transmits the Refresh request from the frame transmitting section 25 (step S59). The processing returns to step S57. This is equivalent to SQ16 in the sequence shown in FIG. 4 and equivalent to SQ36 in the sequence shown in FIG. 5.

On the other hand, when the RefreshMO request is received at step S57 (Yes at step S57), the frame processing unit 244 receives a time stamp of reception timing for the RefreshMO request from the time-stamp generating unit 243 and stores the received time stamp in the time-stamp storing unit 245 as the P00 slave reception time for measurement Ts_rcv. The frame processing unit 244 stores a value in the TS of the RefreshMO request in the time-stamp storing unit 245 as the PDU master transmission time for measurement Tm_snd (step S60). Thereafter, the frame processing unit 244 determines whether new periodical transmission data is present in the transmission-data storing unit 22 (step S61). When periodical transmission data is not stored (No at step S61), the frame processing unit 244 stays in a waiting state until periodical transmission data is stored in the transmission-data storing unit 22. When periodical transmission data is stored (Yes at step S61), the frame processing unit 244 receives a time stamp of transmission timing from the time-stamp generating unit 243, creates a RefreshMO response in which the received time stamp is stored in a TS and the periodical transmission data in the transmission-data storing unit 22 is stored in a data section, and transmits the RefreshMO response from the frame transmitting unit 25 to the master station 1. At this point, the frame processing unit 244 stores the time stamp stored in the TS of the RefreshMO response in the time-stamp storing unit 245 as the PDU slave transmission time for measurement Ts_snd (step S62). This is equivalent to SQ37 in the sequence shown in FIG. 5.

Subsequently, as shown in FIG. 6, the master station 1 determines whether the RefreshMO response is received in the frame receiving unit 16 (step S21). When the RefreshMO response is not received (No at step S21), the frame processing unit 143 further determines whether new periodical transmission data is stored in the transmission-data storing unit 22 (step S22). When periodical transmission data is not stored (No at step S22), the processing returns to step S21. When periodical transmission data is stored (Yes at step S22), the frame processing unit 143 receives a time stamp of transmission timing from the time-stamp generating unit 142, creates a Refresh request in which the received time stamp is stored in a TS and the periodical transmission data in the transmission-data storing unit 22 is stored in a data section, and transmits the Refresh request from the frame transmitting unit 15 to the slave station 2 (step S23). The processing returns to step S21. This is equivalent to SQ33 in the sequence shown in FIG. 5.

On the other hand, when the RefreshMO response is received at step S21 (Yes at step S21), the frame processing unit 143 receives the time stamp Tm_rcv of the reception timing for the RefreshMO response from the time-stamp generating unit 142, temporarily stores the time stamp Tm_rcv, and then further determines whether new periodical transmission data is stored in the transmission-data storing unit 22 (step S24). When periodical transmission data is not stored anew (No at step S24), the frame processing unit 143 stays in a waiting state until transmission data is stored in the transmission-data storing unit 12. When periodical transmission data is stored anew (Yes at step S24), the frame processing unit 143 receives a time stamp of transmission timing from the time-stamp generating unit 142, creates a RefreshGO request in which the received time stamp is stored in a TS, the periodical transmission data in the transmission-data storing unit 22 is stored in a data section, and the time stamp Tm_rcv of the reception timing for the RefreshMO response temporarily stored at step S24 is stored in an OBL, and transmits the RefreshGO request from the frame transmitting unit 15 to the slave station 2 (step S25). This is equivalent to SQ34 in the sequence shown in FIG. 5.

Subsequently, as shown in FIG. 7, the slave station 2 determines whether the RefreshGO request is received in the frame receiving unit 26 (step S63). When the RefreshGO request is not received (No at step S63), the frame processing unit 244 determines whether new periodical transmission data is stored in the transmission-data storing unit 22 (step S64). When periodical transmission data is not stored (No at step S64), the processing returns to step S63. When periodical transmission data is stored (Yes at step S64), the frame processing unit 244 receives a time stamp of transmission timing from the time-stamp generating unit 243, creates a Refresh request in which the received time stamp is stored in a TS and the periodical transmission data in the transmission-data storing unit 22 is stored in a data section, and transmits the Refresh request from the frame transmitting unit 25 (step S65). This is equivalent to SQ38 in the sequence shown in FIG. 5.

On the other hand, when the RefreshGO request is received at step S63 (Yes at step S63), the frame processing unit 244 stores a value stored in the OBL of the received RefreshGO request in the time-stamp storing unit 245 as the PDU master reception time for measurement Tm_rcv. Thereafter, because the RefreshGO request is received, the clock-offset calculating unit 246 calculates a clock offset of the clock 21 of the slave station 2 with respect to the clock 11 of the master station 1 using Formula (3) from Tm_snd, Ts_rcv, Ts_snd, and Tm_rcv stored in the time-stamp storing unit 245. The clock-offset calculating unit 246 adds the calculated clock offset to a value of the clock offset stored in the clock-offset storing unit 242 so far and stores the added-up clock offset in the clock-offset storing unit 242 as a new clock offset (step S66).

Thereafter, the frame processing unit 244 of the slave station 2 determines whether periodical transmission data is stored anew in the transmission-data storing unit 22 (step S67). When periodical transmission data is not stored (No at step S67), the frame processing unit 244 stays in a waiting state until periodical transmission data is stored in the transmission-data storing unit 22. When periodical transmission data is stored (Yes at step S67), the frame processing unit 244 receives a time stamp of transmission timing from the time-stamp generating unit 243, creates a RefreshGO response in which the received time stamp is stored in a TS and the periodical transmission data in the transmission-data storing unit 22 is stored in a data section, and transmits the RefreshGO response from the frame transmitting unit 25 (step S68). Thereafter, the processing returns to step S57. This is equivalent to SQ39 in the sequence shown in FIG. 5.

Subsequently, as shown in FIG. 6, the master station 1 determines whether the RefreshGO response is received in the frame receiving unit 16 (step S26). When the RefreshGO response is received (Yes at step S26), the processing returns to step S17. The frame receiving unit 16 repeatedly executes the processing explained above. When the RefreshGO response is not received (No at step S26), the frame processing unit 143 determines whether periodical transmission data is stored anew in the transmission-data storing unit 12 (step S27). When periodical transmission data is not stored (No at step S27), the processing returns to step S26. When periodical transmission data is stored (Yes at step S27), the frame processing unit 143 receives a time stamp of transmission timing from the time-stamp generating unit 142, generates a Refresh request in which the received time stamp is stored in a TS and the periodical transmission data in the transmission-data storing unit 12 is stored in a data section, and transmits the generated Refresh request from the frame transmitting unit 15 (step S28). The processing returns to step S26. This is equivalent to SQ35 in the sequence shown in FIG. 5.

As explained above, a measurement instruction and a calculation instruction for a clock offset and offset generation information are included in a periodical communication frame including an instruction for refresh processing exchanged during the periodical communication between the master station 1 and the slave station 2. Therefore, it is possible to perform calculation of a clock offset during the periodical communication.

Delay detection processing is explained next. In the first embodiment, as the delay detection processing, the master station 1 performs one-way delay detection processing using a PDU transmitted from the slave station 2 and performs round-trip delay detection processing using a PDU exchange in a request response sequence. The slave station 2 performs one-way delay detection processing.

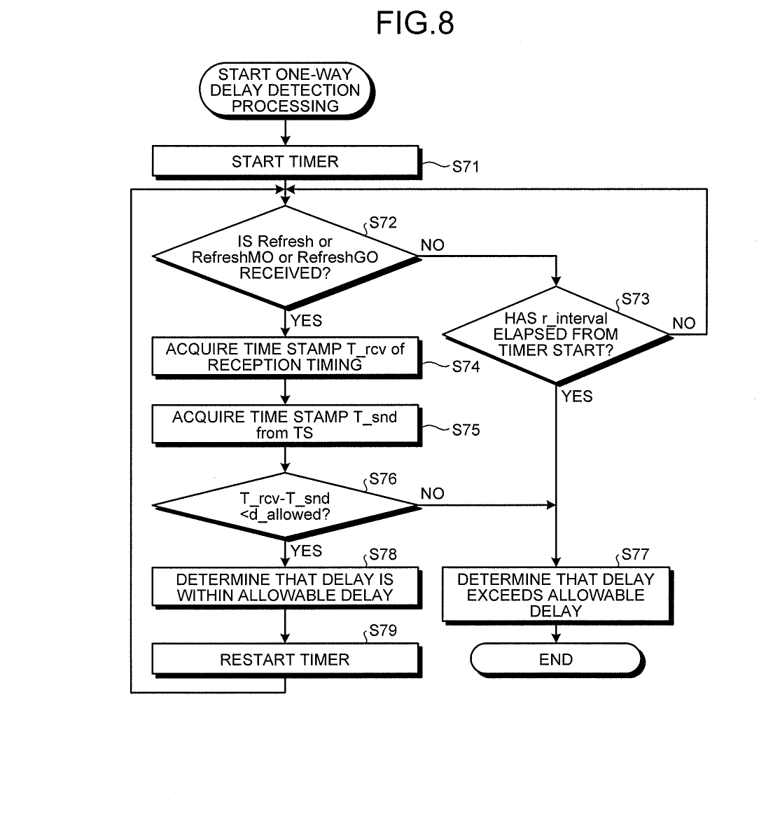

FIG. 8 is a flowchart for explaining an example of a procedure of one-way delay detection processing according to the first embodiment. First, the one-way delay detection processing in the master station 1 is explained. The start of the periodical communication between the master station 1 and the slave station 2 gives the opportunity to the one-way-delay detecting unit 145 of the master station 1 to start a timer using the clock 11 (step S71). The start of the periodical communication in the master station 1 is at timing when the RefreshGO response in SQ14 shown in FIG. 4 is received from the slave station 2.

Subsequently, the one-way-delay detecting unit 145 determines whether a Refresh request, a RefreshMO response, or a RefreshGO response is received in the frame receiving unit 16 (step S72). If none of a Refresh request, a RefreshMO response, and a RefreshGO response is received (No at step S72), the one-way-delay detecting unit 145 determines whether the predetermined period (the first delay allowable time) r_interval has elapsed from the timer start (step S73). When the predetermined period has not elapsed (No at step S73), the processing returns to step S72. When the predetermined period has elapsed (Yes at step S73), the one-way-delay detecting unit 145 determines that a delay has exceeded an allowable delay (step S77). When it is determined that a delay has exceeded the allowable delay, the master station 1 is disconnected and communication is stopped. The processing ends.

On the other hand, when any one of a Refresh request, a RefreshMO response, and a RefreshGO response is received at step S72 (Yes at step S72), the one-way-delay detecting unit 145 receives a time stamp of reception timing for the Refresh request, the RefreshMO response, or the RefreshGO response from the time-stamp generating unit 142 and stores the time stamp in the time-stamp storing unit 144 as the PDU reception time T_rcv (step S74). The one-way-delay detecting unit 145 stores a value stored in a TS of the received Refresh request, RefreshMO response, or RefreshGO response in the time-stamp storing unit 144 as the PDU transmission time T_snd (step S75).

Subsequently, the one-way-delay detecting unit 145 determines whether a difference between the PDU reception time T_rcv and the PDU transmission time T_snd stored in the time-stamp storing unit 144 at steps S74 and S75, i.e., time in which the refresh instruction PDU is transmitted from the slave station 2 and reaches the master station 1 is smaller than the second delay allowable time d_allowed set in advance (step S76).

As a result of the determination, when the difference between the PDU reception time T_rcv and the PDU transmission time T_snd is equal to or larger than the second delay allowable time d_allowed (No at step S76), the one-way-delay detecting unit 145 determines that a delay has exceeded the allowable delay (step S77). The processing ends. When the difference between the PDU reception time T_rcv and the PDU transmission time T_snd is smaller than the second delay allowable time d_allowed (Yes at step S76), the one-way-delay detecting unit 145 determines that a delay is within the allowable delay (step S78) and restarts the timer (step S79). The processing returns to step S72. The one-way delay detection processing in the master station 1 is performed as explained above.

The one-way delay detection processing in the slave station 2 is explained. The one-way delay detection processing in the slave station 2 is basically the same as the one-way delay detection processing in the master station 1. However, the one-way delay detection processing in the station 2 is different from the one-way delay processing in the master station 1 in points explained below. The start of the periodical communication at the timing for starting the timer at step S71 is at a timing when the RefreshGO request in SQ43 shown in FIG. 4 is received from the master station 1. At step S72, it is determined whether a Refresh request, a RefreshMO request, or a RefreshGO request is received. At step S74, a time stamp of reception timing for the received Refresh request, RefreshMO request, or RefreshGO request is received from the time-stamp generating unit 243 and stored in the time-stamp storing unit 245 as the PDU reception time T_rcv. Further, at step S75, a value stored in a TS of the received Refresh request, RefreshMO request, or RefreshGO request is stored in the time-stamp storing unit 245 as the PDU transmission time T_snd.

As explained above, in the one-way delay detection processing, the one-way delay detection processing can be performed using a periodical communication frame including an instruction for refresh processing in which a time stamp of time transmitted by a partner node is stored. Delay detection is performed every time the periodical communication frame including the instruction for the refresh processing is received. Therefore, it is possible to quickly detect a delay.

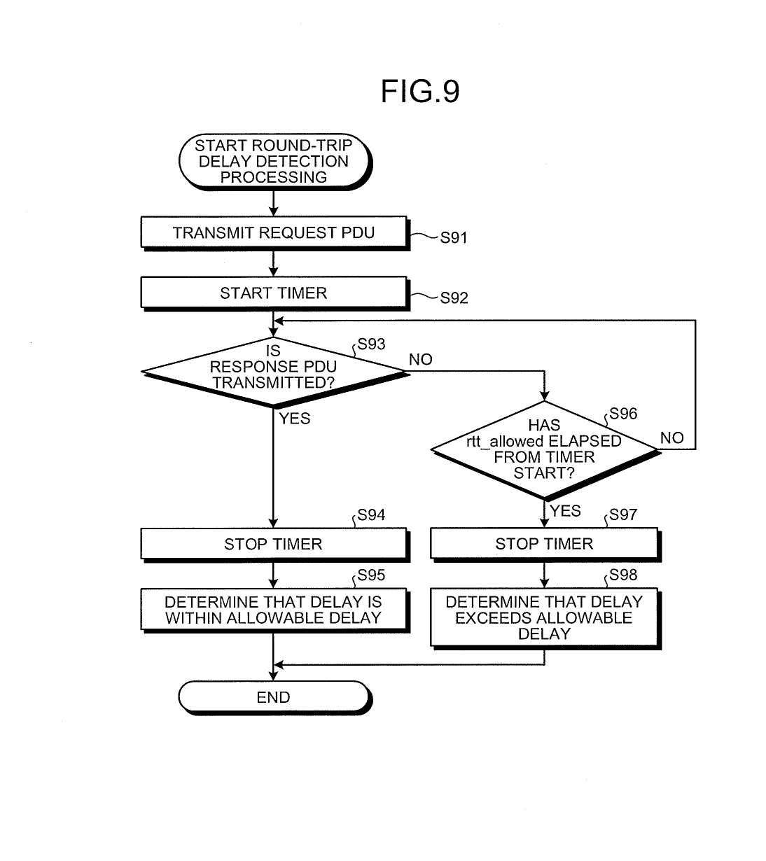

FIG. 9 is a flowchart for explaining an example of a procedure of the round-trip delay detection processing in the master station according to the first embodiment. First, upon transmitting a request PDU from the frame transmitting unit 15 (step S91), the round-trip-delay detecting unit 146 starts a timer (step S92). Subsequently, the round-trip-delay detecting unit 146 determines whether a response PDU corresponding to the request PDU has been received (step S93). When the response PDU has been received (Yes at step S93), the round-trip-delay detecting unit 146 stops the timer (step S94) and determines that a delay has exceeded an allowable delay (step S95). The processing ends.

When the response PDU has not been received at step S93 (No at step S93), the round-trip-delay detecting unit 146 determines whether the predetermined time (the round-trip delay allowable time) rtt_allowed has elapsed from the start of the timer (step S96). When the predetermined time has not elapsed (No at step S96), the processing returns to step S93. On the other hand, when the predetermined time has elapsed from the start of the timer (Yes at step S96), the round-trip-delay detecting unit 146 stops the timer (step S97) and determines that a delay has exceeded the allowable delay (step S98). When it is determined that a delay has exceeded the allowable delay, the master station 1 is disconnected and communication is stopped. Consequently, the processing ends.

At step S93, the round-trip-delay detecting unit 146 checks whether the received response PDU is a response PDU corresponding to the request PDU transmitted at step S91. Specifically, when the request PDU transmitted at step S91 is a request PDU transmitted before offset calculation, a RefreshReady request, and a request PDU in communication other than the periodical communication, the round-trip-delay detecting unit 146 checks whether a TS of the request PDU transmitted at step S91 and a TS of the response PDU received at step S93 coincide with each other. When the TSs coincide with each other, the round-trip-delay detecting unit 146 determines that the response PDU is a response corresponding to the request PDU. When the request PDU transmitted at step S91 is a RefreshMO request and a RefreshGO request, the round-trip-delay detecting unit 146 confirms whether PDU association information included in a CTRL of the request PDU transmitted at step S91 coincides with PDU association information included in a CTLR of the response PDU received at step S93. When the pieces of PDU association information coincide with each other, the round-trip-delay detecting unit 146 determines that the response PDU is a response corresponding to the request PDU.

As explained above, in the case of a sequence in which the master station 1 transmits a request PDU to the slave station 2 and the slave station 2 transmits a response PDU corresponding to the request PDU to the master station 1, it is possible to detect whether a round-trip delay is within the allowable delay. The delay detection processing is switched according to a type of communication such that the round-trip delay detection processing by the round-trip-delay detecting unit 146 is performed in time other than the periodical communication time and the one-way delay detection processing by the one-way-delay detecting unit 145 is performed in the periodical communication time. Consequently, it is possible to perform the delay detection in every scene of communication on the network.

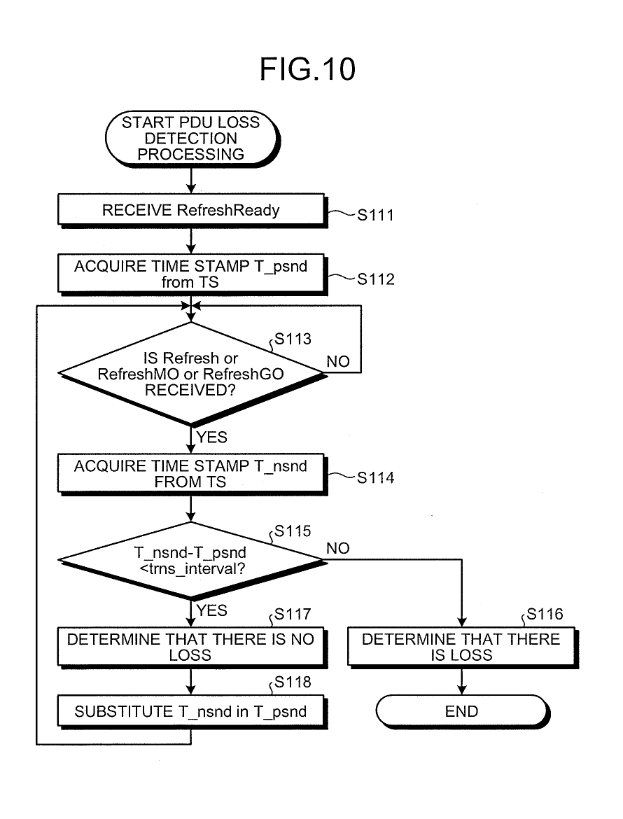

PDU loss detection processing is explained. FIG. 10 is a flowchart for explaining an example of a procedure of PDU loss detection processing according to the first embodiment. First, PDU loss detection processing in the master station 1 is explained. When a RefreshReady response is received in the frame receiving unit 16 (step S111), the loss detecting unit 147 stores a value stored in a TS of the received RefreshReady response in the time-stamp storing unit 144 as the last PDU transmission time T_psnd (step S112). Subsequently, the loss detecting unit 147 determines whether a Refresh request, RefreshMO response, or a RefreshGO response has been received (step S113). When none of a Refresh request, RefreshMO response, and a RefreshGO response has been received (No at step S113), the loss detecting unit 147 stays in a waiting state until a Refresh request, RefreshMO response, or a RefreshGO response is received.

When Refresh request, RefreshMO response, or a RefreshGO response has been received (Yes at step S113), the loss detecting unit 147 stores a value stored in a TS of the received Refresh request, RefreshMO response, or RefreshGO response in the time-stamp storing unit 144 as the present PDU transmission time T_nsnd (step S114). Thereafter, the loss detecting unit 147 determines whether a difference between the present PDU transmission time T_nsnd and the last PDU transmission time T_psnd stored in the time-stamp storing unit 144 is smaller than a loss evaluation time trns_interval that means an allowable reception interval (step S115).

As a result of the determination, when the difference between the present PDU transmission time T_nsnd and the last PDU transmission time T_psnd is equal to or larger than the loss evaluation time trns_interval (No at step S115), the loss detecting unit 147 determines that there is a loss of a PDU (step S116). Processing for, for example, disconnecting the master station 1 to stop communication is performed. The PDU loss detection processing ends. When the difference between the present PDU transmission time T_nsnd and the last PDU transmission time T_psnd is smaller than the loss evaluation time trns_interval (Yes at step S115), the loss detecting unit 147 determines that there is no loss of a PDU (step S117). The loss detecting unit 147 stores, as a new last PDU transmission time T_psnd, the present PDU transmission time T_nsnd stored in the time-stamp storing unit 144 at step S114 (step S118). Thereafter, the processing returns to step S113. the loss detecting unit 147 repeatedly executes the processing explained above.

Loss detection processing in the slave station 2 is explained. The loss detection processing in the slave station 2 is basically the same as the loss detection processing in the master station 1. However, the loss detection processing in the slave station 2 is different from the loss detection processing in the master station 1 in that a RefreshReady request is received at step S111 and that it is determined at step S113 whether a Refresh request, a RefreshMO request, or a RefreshGO request is received.

As explained above, in the PDU loss detection processing, it is possible to perform the PDU loss detection processing using a periodical communication frame including an instruction for refresh processing in which a time stamp of time transmitted by a partner node is stored. The PDU loss detection processing is performed every time the periodical communication frame including the instruction for the refresh processing is received. Therefore, it is possible to quickly detect a PDU loss.

In the delay detection processing and the PDU loss detection processing explained above, when the one-way delay detecting unit 145 and the round-trip delay detecting unit 146 of the master station 1 determine that a delay is within the allowable delay and the loss detecting unit 147 determines that there is no loss of a PDU, data stored in a data section of the Refresh request, the RefreshMO response, and the RefreshGO response received from the slave station 2 is stored in the reception-data storing unit 13.

When the one-way-delay detecting unit 247 of the slave station 2 determines that a delay is within the allowable delay and the loss detecting unit 248 determines that there is no loss of a PDU, data stored in a data section of the Refresh request, the RefreshMO request, and the RefreshGO request received from the master station 1 is stored in the reception-data storing unit 23.

The operations of the one-way-delay detecting units 145 and 247 performed when there is fluctuation in transmission intervals of the frame transmitting units 15 and 25 of the master station 1 and the slave station 2 are explained. It is assumed that there is fluctuation in transmission intervals and a second PDU among three PDUs (first to third PDUs, e.g., PDUs transmitted in SQ31 to SQ33 shown in FIG. 5) transmitted in the periodical communication is lost. In this case, in evaluation concerning whether a PDU is lost performed at S115 of FIG. 10 by the one-way-delay detecting units 145 and 247 during reception of the third PDU, a difference between T_nsnd stored in a TS of the third PDU and T_psnd stored in a TS of the first PDU is prevented from being smaller than the loss evaluation time trns_interval in the PDU loss detection processing. Therefore, the one-way-delay detecting units 145 and 247 of the master station 1 and the slave station 2 perform operations explained below such that a transmission interval is larger than a half of the loss evaluation time trns_interval.

At steps (S15, S19, S20, S23, S25, and S28) for transmitting a Refresh request, a RefreshMO request, and a RefreshGO request (a refresh instruction frame including an instruction for the refresh processing), after transmitting the refresh instruction frame, the one-way-delay detecting unit 145 of the master station 1 stores, as final transmission timing, a time stamp stored in a TS of the transmitted refresh instruction frame. When the refresh instruction frame is transmitted next, the one-way-delay detecting unit 145 waits until a difference between the final transmission timing and the present transmission timing exceeds a half of the loss evaluation time trns_interval. When the difference exceeds a half of the loss evaluation time, the one-way-delay detecting unit 145 transmits the refresh instruction frame from the frame transmitting unit 15.

At steps (S56, S59, S62, S65, and S68) for transmitting a Refresh request, a RefreshMO response, and a RefreshGO response (a refresh instruction frame) in FIG. 7, after transmitting the refresh instruction frame, the one-way-delay detecting unit 247 of the slave station 2 stores, as final transmission timing, a time stamp stored in a TS of the transmitted refresh instruction frame. When the refresh instruction frame is transmitted next, the one-way-delay detecting unit 247 waits until a difference between the final transmission timing and the present transmission timing exceeds a half of the loss evaluation time trns_interval. Then, the one-way-delay detecting unit 247 transmits the refresh instruction frame from the frame transmitting unit 25.

According to the first embodiment, a region in which information for calculating a clock offset is stored is provided in a PDU exchanged between two nodes during the periodical communication in addition to a region in which data to be transmitted is stored and a region in which a time stamp used for detection of a delay and a loss is stored. A clock offset between the two nodes is calculated based on the time stamp used for detection of a delay and a loss and information for calculating an offset. Consequently, it is unnecessary to transmit a new PDU for clock offset calculation besides the PDU exchanged during the periodical communication. The size of the PDU does not change. Therefore, when the embodiment is applied to an apparatus that operates at a predetermined processing period such as a programmable controller that performs sequence control, there is an effect that it is possible to prevent influence on periodical data processing.

A delay measuring method is switched to perform round-trip delay measurement at the time other than the periodical communication time and perform one-way delay measurement at the periodical communication time. Consequently, when the delay measuring method is applied to a system that transmits and receives input and output information from an input and output apparatus such as a sensor or an actuator at a predetermined processing period such as a programmable controller system that performs sequence control, it is possible to reduce time until a delay and a loss of the input and output information are detected.

Further, even when there is fluctuation in a generation period of periodical communication data, a transmission side transmits the periodical communication data after a half of a loss evaluation time used for loss determination on a reception side elapses from the last transmission timing. Therefore, it is possible to prevent determination that a loss has not occurred although a loss has occurred on the transmission side and surely detect a loss.

### Second Embodiment

In the first embodiment, the size of time information stored in a TS of a PDU is not explained. In the second embodiment, the size of time information set to an arbitrary size is explained.

In an example explained in the second embodiment, both the clocks 11 and 21 of the master station 1 and the slave station 2 are clocks having 48-bit width and the size of a TS of a PDU is limited to 16 bits.

The time-stamp generating unit 142 of the master station 1 according to the second embodiment generates low-order 16 bits of time information generated by the clock 11 as a time stamp. The time-stamp generating unit 243 of the slave station 2 calculates a sum of the clock 21 and a time offset stored in the clock-offset storing unit 242 and generates low-order 16 bits of a calculated value as a time stamp.

Differences from the first embodiment in clock offset calculation processing, one-way delay detection processing, and PDU loss detection processing in the second embodiment are explained below.

Connection Establishment Processing by the Master station 1

During the connection establishment request processing at step S11 in FIG. 6, the frame processing unit 143 of the master station 1 generates a communication frame in which a value of high-order 32 bits of the clock 11 is stored and transmits the communication frame from the frame transmitting unit 15 to the slave station 2. The frame processing unit 143 stores the value of the high-order 32 bits of the clock 11 in the time-stamp storing unit 144 as clock high-order bit information up_clk_s_d, up_clk_s_l.

Connection Establishment Processing by the Slave Station 2

During the connection establishment request processing at step S51 in FIG. 7, the frame processing unit 244 of the slave station 2 also performs processing for storing the value of the high-order 32 bits of the clock 11 received from the master station 1 in the time-stamp storing unit 245. At this point, the frame processing unit 244 stores the value of the high-order 32 bits of the clock 11 as high-order bit information for response PDU transmission time generation np_clk, high-order bit information for request PDU transmission time generation up_clk_d_s, high-order bit information for request PDU reception time generation up_clk_d_r, and high-order bit information for loss detection PDU time generation up_clk_l. The high-order bit information for request PDU transmission time generation up_clk_d_s is stored in association with the PDU transmission time T_snd, the high-order bit information for request PDU reception time generation up_clk_d_r is stored in association with the PDU reception time T_rcv, and the high-order bit information for loss detection PDU time generation up_clk_l is stored in association with the last PDU transmission time T_psnd and the present PDU transmission time T_nsnd.

Check Code Generation Processing by the Master Station 1

In the steps of transmitting a Refresh request, a RefreshMO request, and a RefreshGO request at steps S15, S19, S20, S23, S25, and S28 in FIG. 6, the frame processing unit 143 of the master station 1 also performs processing for storing, in a trailer section of a PDU to be transmitted, a check code generated from high-order 32 bits of time information generated by the clock 11 and a header section and a data section of the PDU.

Check Code Setting Processing During PDU Transmission by the Slave Station 2

In the steps of transmitting a Refresh request, a RefreshMO response, and a RefreshGO response at steps S55, S59, S62, S65, and S68 in FIG. 7, the frame processing unit 244 of the slave station 2 also performs processing for storing, in a trailer section of a PDU to be transmitted, a check code generated from high-order 32 bits of time information generated by the clock 11 and a header section and a data section of the PDU.

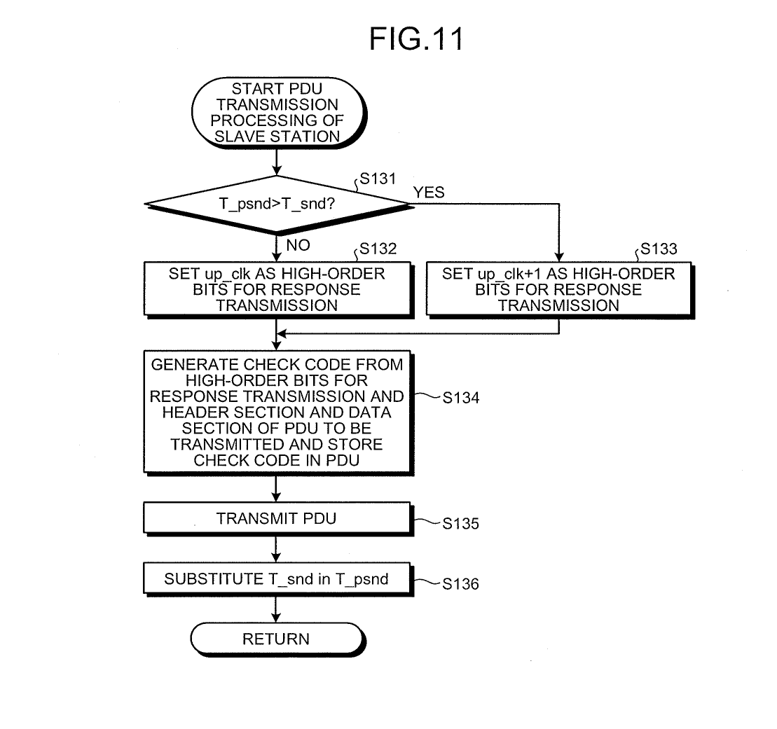

FIG. 11 is a flowchart of an example of a procedure of check code setting processing at PDU transmission time of the slave station according to the second embodiment. First, the frame processing unit 244 determines whether the last PDU transmission time T_psnd, which is timing when a Refresh request, a RefreshMO response, or a RefreshGO response is transmitted last time, is larger than the PDU transmission time T_snd, which is a timing at which a request is transmitted this time (step S131). When the last PDU transmission time T_psnd is equal to or smaller than the PDU transmission time T_snd (No at step S131), the frame processing unit 244 sets, in a high-order bit for response transmission, the high-order bit information for response PDU transmission time generation up_clk acquired from the time-stamp storing unit 245 (step S132). On the other hand, when the PDU transmission time T_psnd is larger than the PDU transmission time T_snd (Yes at step S131), the frame processing unit 244 sets, in a high-order bit for response transmission, bit information obtained by incrementing, by one, the high-order bit information for response PDU transmission time generation acquired from the time-stamp storing unit 245 (step S133). The frame processing unit 244 stores high-order bit information for response PDU transmission time generation up_clk+1 incremented by one obtained at step S133 in the time-stamp storing unit 245 as new high-order bit information for response PDU transmission time generation up_clk.

Subsequently, the frame processing unit 244 generates a check code from the set high-order bit for response transmission and a header section and a data section of a PDU to be transmitted and stores the generated check code in a trailer section of the PDU to be transmitted (step S134). After transmitting the PDU (step S135), the frame processing unit 244 stores the PDU transmission time T_snd of the PDU to be transmitted this time in the time-stamp storing unit 245 as T_psnd (step S135). The processing ends.

On-Way Delay Detection Processing

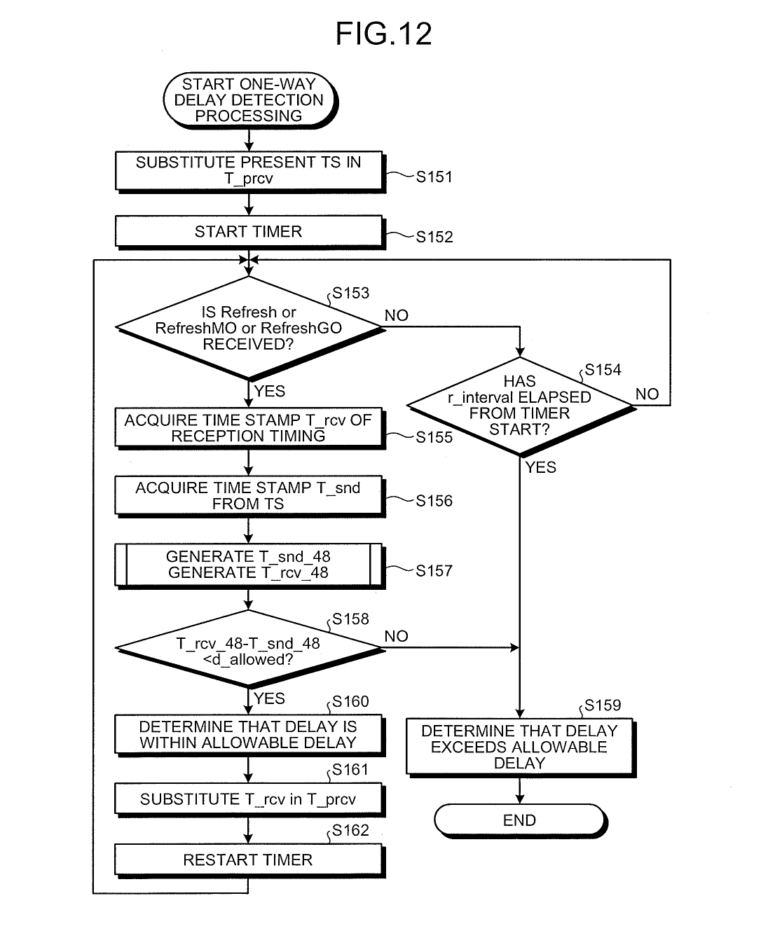

FIG. 12 is a flowchart for explaining an example of a procedure of the one-way delay detection processing according to the second embodiment. In the following explanation, first, one-way delay detection processing by the master station 1 is explained and then one-way delay detection processing by the slave station 2 is explained.

One-Way Delay Detection Processing by the Master Station 1

First, the one-way-delay detecting unit 145 of the master station 1 receives a time stamp currently generated by the time-stamp generating unit 142 and stores the received time stamp in the time-stamp storing unit 144 as the last PDU reception time T_prcv (step S151). Subsequently, the start of the periodical communication in the master station 1 gives the opportunity to the one-way-delay detecting unit 145 to start the timer using the clock 11 (step S152). The start of the periodical communication in the master station 1 is at timing when the RefreshGO response in SQ14 shown in FIG. 4 is received from the slave station 2.

Subsequently, the one-way-delay detecting unit 145 determines whether a Refresh request, a RefreshMO response, or a RefreshGO response has been received in the frame receiving unit 16 (step S153). When none of a Refresh request, a RefreshMO response, and a RefreshGO response has been received (NO at step S153), the one-way-delay detecting unit 145 determines whether the predetermined time (the first delay allowable time) r_interval has elapsed from the timer start (step S154). When the predetermined time has not elapsed (No at step S154), the processing returns to step S153. When the predetermined time has elapsed at step S154 (Yes at step S154), the one-way-delay detecting unit 145 determines that a delay has exceeded an allowable delay (step S159) and performs processing for, for example, disconnecting the master station 1. The processing ends.

On the other hand, when any one of a Refresh request, a RefreshMO response, or a RefreshGO response is received at step S153 (Yes at step S153), the one-way-delay detecting unit 145 receives a time stamp of reception timing for the Refresh request, the RefreshMO response, or the RefreshGO response from the time-stamp generating unit 142 and stores the time stamp in the time-stamp storing unit 144 as the PDU reception time T_rcv (step S155). The one-way-delay detecting unit 145 stores a value stored in a TS of the received Refresh request, RefreshMO response, or RefreshGO response in the time-stamp storing unit 144 as the PDU transmission time T_snd (step S156).

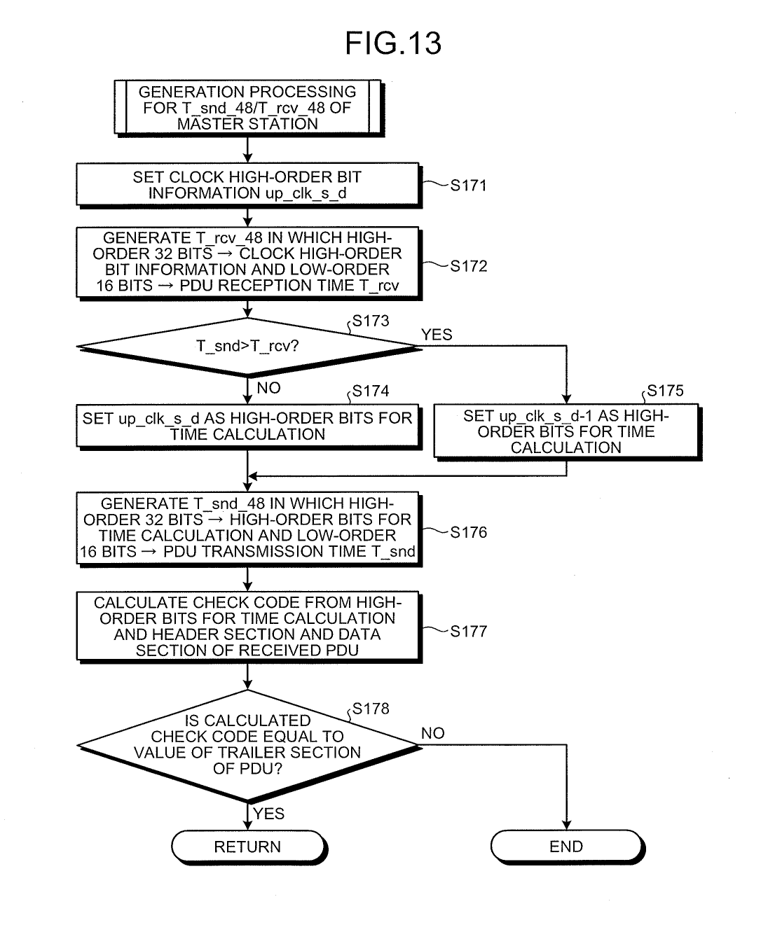

Subsequently, the one-way-delay detecting unit 145 generates a 48-bit PDU transmission time T_snd_48 and a 48-bit PDU reception time T_rcv_48 (step S157). FIG. 13 is a flowchart for explaining an example of a procedure of generation processing for a 48-bit PDU transmission time and a 48-bit PDU reception time by the master station.

First, the one-way-delay detecting unit 145 of the master station 1 sets high-order 32 bits of the clock 11 as clock high-order bit information up_clk_s_d (step S171). Subsequently, the one-way-delay detecting unit 145 generates the 48-bit PDU reception time T_rcv_48 in which the high-order 32 bits are set as clock high-order bit information up_clk_s_d and low-order 16 bits are set as the PDU reception time T_rcv (step S172).

Thereafter, the one-way-delay detecting unit 145 determines whether the PDU transmission time T_snd is larger than the PDU reception time T_rcv (step S173). When the PDU transmission time T_snd is equal to or smaller than the PDU reception time T_rcv (No at step S173), the one-way-delay detecting unit 145 sets the clock high-order bit information up_clk_s_d as high-order bits for time calculation (step S174). On the other hand, when the PDU transmission time T_snd is larger than the PDU reception time T_rcv (Yes at step S173), the one-way-delay detecting unit 145 sets, as the high-order bits for time calculation, high-order bit information obtained by decrementing the clock high-order bit information up_clk_s by one (step S175).

Subsequently, the one-way-delay detecting unit 145 generates the 48-bit PDU transmission time T_snd_48 in which high-order 32 bits are set as the high-order bits for time calculation set at step S174 or S175 and low-order 16 bits are set as the PDU transmission time T_snd (step S176). Thereafter, the one-way-delay detecting unit 145 calculates a check code from the set high-order bits for time calculation and a header section and a data section of a received PDU (step S177). The one-way-delay detecting unit 145 determines whether the calculated check code is equal to a value stored in a trailer section of the received PDU (step S178). When the check code and the value do not coincide with each other (step S178), the one-way-delay detecting unit 145 determines that abnormality has occurred. The processing ends. When the check code and the value are equal (Yes at step S178), the processing returns to the processing shown in FIG. 12.

Referring back to FIG. 12, the one-way-delay detecting unit 145 determines whether a difference between the 48-bit PDU reception time T_rcv_48 and the 48-bit PDU transmission time T_snd_48 is smaller than the second delay allowable time d_allowed (step S158). As a result of the determination, when the difference between the 48-bit PDU reception time T_rcv_48 and the 48-bit PDU transmission time T_snd_48 is equal to or larger than than the second delay allowable time d_allowed (No at step S158), the one-way-delay detecting unit 145 determines that a delay has exceeded the allowable delay (step S159). For example, processing for disconnecting the master station 1 is performed. The processing ends. When the difference between the 48-bit PDU reception time T_rcv_48 and the 48-bit PDU transmission time T_snd_48 is smaller than the second delay allowable time d_allowed (Yes at step S158), the one-way-delay detecting unit 145 determines that a delay is within the allowable delay (step S160). Thereafter, the one-way-delay detecting unit 145 stores the PDU reception time T_rcv stored in the time-stamp storing unit 144 in the time-stamp storing unit 144 as the last PDU reception time T_prcv (step S161) and restarts the timer (step S162). The processing returns to step S153. As explained above, the one-way delay detection processing in the master station 1 is performed.

One-Way Delay Detection Processing by the Slave Station 2

The one-way delay detection processing in the slave station 2 is basically the same as the one-way delay detection processing in the master station 1. However, differences from the one-way delay detection processing in the master station 1 are explained below. The start of the periodical communication at the timing for starting the timer at step S152 is at timing when the RefreshGO request in SQ43 shown in FIG. 4 is received from the master station 1. At step S153, it is determined whether a Refresh request, a RefreshMO request, or a RefreshGO request has been received. At step S155, a time stamp of reception timing for the received Refresh request, RefreshMO request, or RefreshGO request is received from the time-stamp generating unit 243 and stored in the time-stamp storing unit 245 as the PDU reception time T_rcv. Further, at step S156, a value stored in a TS of the received Refresh request, RefreshMO request, or RefreshGO request is stored in the time-stamp storing unit 245 as the PDU transmission time T_snd.

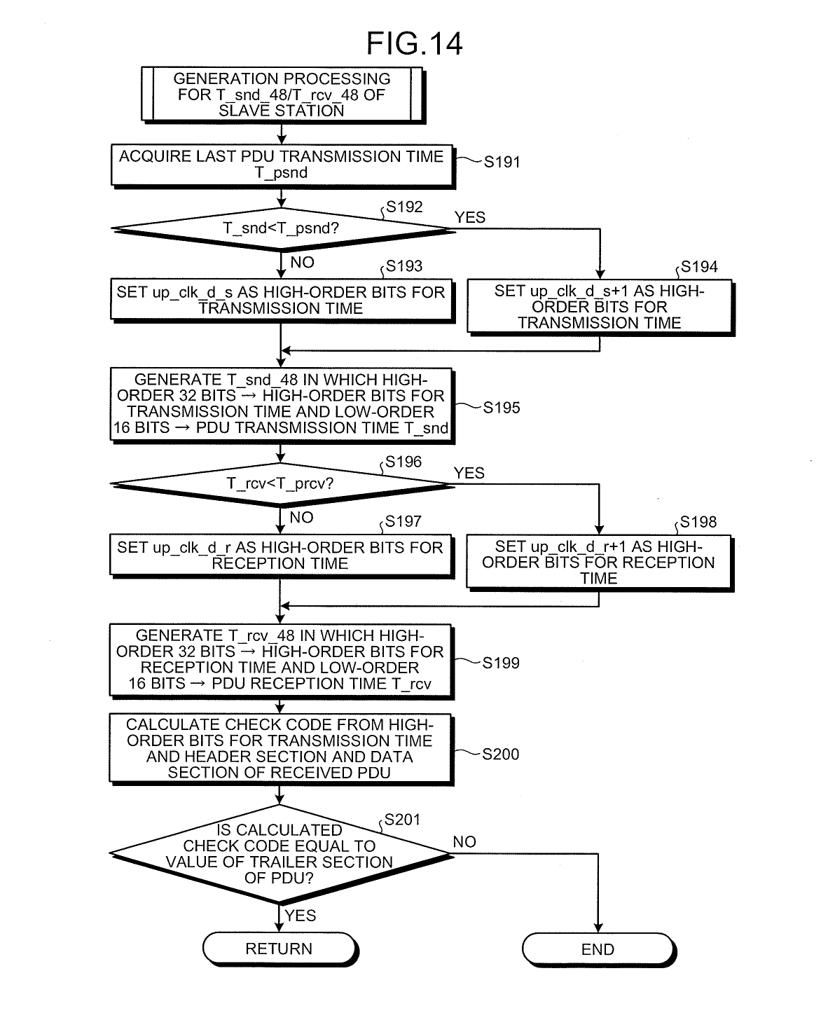

The generation processing for the 48-bit PDU transmission time T_snd_48 and the 48-bit PDU reception time T_rcv_48 at step S158 is different from the generation processing performed in the master station 1. FIG. 14 is a flowchart for explaining an example of a procedure of the generation processing for a 48-bit PDU transmission time and a 48-bit PDU reception time by the slave station.

First, the one-way-delay detecting unit 247 of the slave station 2 acquires the last PDU transmission time T_psnd used in the loss detecting unit 248 from the time-stamp storing unit 245 (step S191). Subsequently, the one-way-delay detecting unit 247 determines whether the PDU transmission time T_snd stored in a TS of the received Refresh request, RefreshMO request, or RefreshGO request acquired at step S156 is smaller than the last PDU transmission time T_psnd acquired at step S191 (step S192). When the PDU transmission time T_snd is equal to or larger than the last PDU transmission time T_psnd (No at step S192), the one-way-delay detecting unit 247 sets, as high-order bits for transmission time, the high-order bit information for request PDU transmission time generation up_clk_d_s acquired from the time-stamp storing unit 245 (step S193). On the other hand, when the PDU transmission time T_snd is smaller than the last PDU transmission time T_psnd (Yes at step S192), the one-way-delay detecting unit 247 sets, as high-order bits for transmission time, high-order bit information obtained by incrementing, by one, the high-order bit information for request PDU transmission time generation up_clk_d_s acquired from the time-stamp storing unit 245 (step S194). The one-way-delay detecting unit 247 sets up_clk_d_s+1 obtained at step S194 in the time-stamp storing unit 245 as new high-order bit information for request PDU transmission time generation up_clk_d_s.

Therefore, the one-way-delay detecting unit 247 generates the 48-bit PDU transmission time T_snd_48 in which high-order 32 bits are set as the high-order bits for transmission time set at step S193 or S194 and low-order 16 bits are set as the PDU transmission time T_snd (step S195).

Subsequently, the one-way-delay detecting unit 247 determines whether the PDU reception time T_rcv acquired at step S155 in FIG. 12 is smaller than the last PDU reception time T_prcv acquired at step S151 (step S196). As a result of the determination, when the PDU reception time T_rcv is equal to or larger than the last PDU reception time T_prcv (No at step S196), the one-way-delay detecting unit 247 sets, as high-order bits for reception time, the high-order bit information for request PDU reception time generation up_clk_d_r acquired from the time-stamp storing unit 245 (step S197). On the other hand, when the POD reception time T_rcv is smaller than the last PDU reception time T_prcv (Yes at step S196), the one-way-delay detecting unit 247 sets, as high-order bits for reception time, high-order bit information obtained by incrementing, by one, the high-order bit information for request PDU reception time generation up_clk_d_r acquired from the time-stamp storing unit 245 (step S198). The one-way-delay detecting unit 247 stores up_clk_d_r+1 obtained at step S198 in the time-stamp storing unit 245 as new high-order bit information for request PDU reception time generation up_clk_d_r.

Thereafter, the one-way-delay detecting unit 247 generates the 48-bit PDU reception time T_rcv_48 in which high-order 32 bits are set as the high-order bits for reception time set at step S197 or S198 and low-order 16 bits are set as the PDU reception time T_rcv (step S199).

Subsequently, the one-way-delay detecting unit 247 calculates a check code from the high-order bits for transmission time set at step S193 or S194 and a header section and a data section of a received PDU (step S200). The one-way-delay detecting unit 247 determines whether the calculated check code is equal to a value stored in a trailer section of the received PDU (step S201). When the check code and the value do not coincide with each other (step S201), the one-way-delay detecting unit 247 determines that abnormality has occurred. The processing ends. When the check code and the value are equal (Yes at step S201), the processing returns to the processing shown in FIG. 12.

Loss Detection Processing

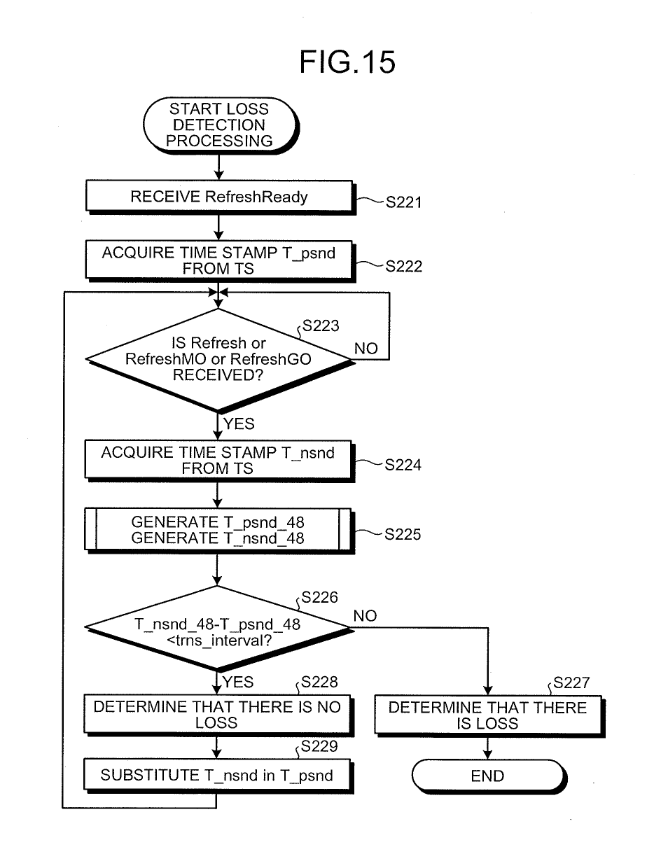

FIG. 15 is a flowchart for explaining an example of a procedure of the loss detection processing according to the second embodiment. In the following explanation, first, loss detection processing by the master station 1 is explained and then loss detection processing by the slave station 2 is explained.

Loss Detection Processing by the Master Station 1

Upon receiving a RefreshReady response (step S221), the loss detecting unit 147 of the master station 1 stores a value stored in a TS of the received RefreshReady response in the time-stamp storing unit 144 as the last PDU reception time T_psnd (step S222). Thereafter, the loss detecting unit 147 determines whether any one of a Refresh request, a RefreshMO response, and a RefreshGO response has been received (step S223). If none of a Refresh request, a RefreshMO response, and a RefreshGO response has been received (No at step S223), the loss detecting unit 147 stays in a waiting state until a Refresh request, a RefreshMO response, or a RefreshGO response is received.

If a Refresh request, a RefreshMO response, or a RefreshGO response has been received (Yes at step S223), the loss detecting unit 147 stores a value stored in a TS of the received Refresh request, RefreshMO response, or RefreshGO response in the time-stamp storing unit 144 as the present PDU transmission time T_snd, and stores a reception time of the Refresh request, the RefreshMO response, or the RefreshGO response as the frame reception time T_rcv (step S224).

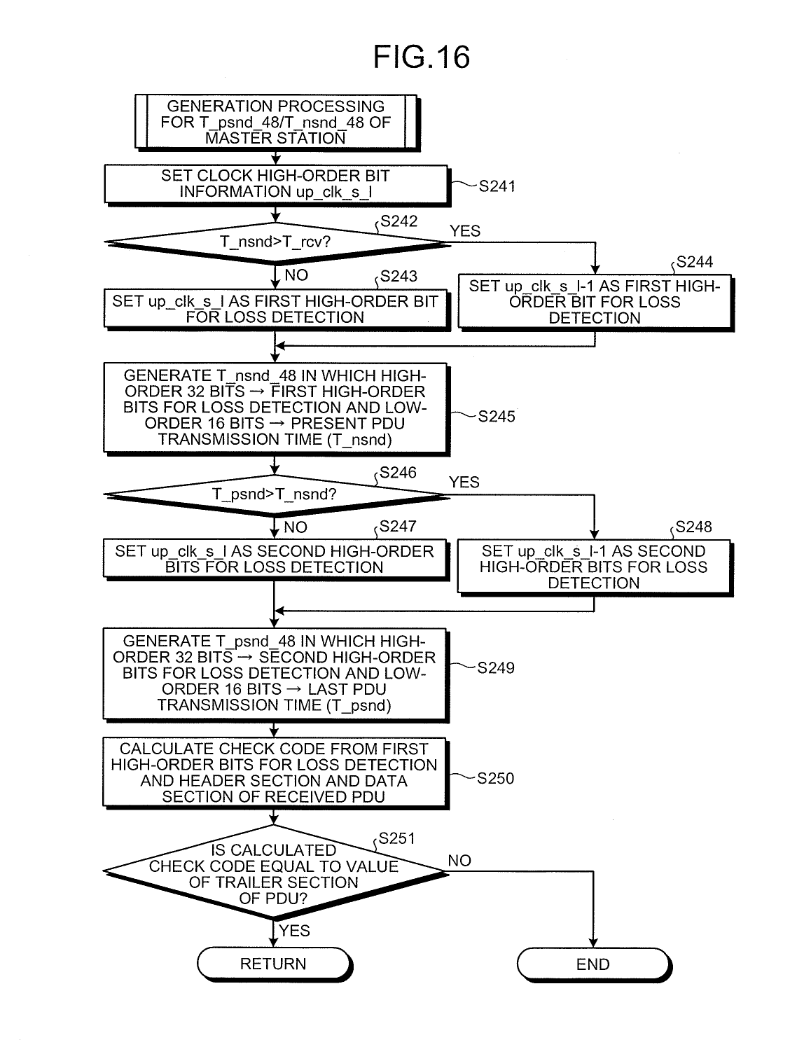

Subsequently, the loss detecting unit 147 generates the 48-bit last PDU transmission time T_psnd_48 and the 48-bit present PDU transmission time T_nsnd_48 (step S225). FIG. 16 is a flowchart for explaining an example of a procedure of generation processing for 48-bit PDU transmission time and 48-bit PDU reception time by the master station.

First, the loss detecting unit 147 of the master station 1 sets high-order 32 bits of the clock 11 as the clock high-order bit information up_clk_s_l (step S241). Subsequently, the loss detecting unit 147 determines whether the present PDU transmission time T_nsnd acquired at step S224 is larger than the frame reception time T_rcv of the Refresh request, the RefreshMO response, or the RefreshGO response received at step S2243 (step S242). When the present PDU transmission time T_nsnd is equal to or smaller than the frame reception time T_rcv (No at step S242), the loss detecting unit 147 sets the clock high-order bit information up_clk_s_l as first high-order bits for loss detection (step S243). On the other hand, when the present PDU transmission time T_nsnd is larger than the frame reception time T_rcv (Yes at step S242), the loss detecting unit 147 sets, as first high-order bits for loss detection, high-order bit information obtained by decrementing the clock high-order bit information up_clk_s_l by one (step S244).

Subsequently, the loss detecting unit 147 generates the 48-bit present PDU transmission time T_nsnd_48 in which high-order 32 bits are set as the first high-order bits for loss detection and low-order 16 bits are set as the present PDU transmission time T_nsnd (step S245).

Subsequently, the loss detecting unit 147 determines whether the last PDU transmission time T_psnd is larger than the present PDU transmission time T_nsnd (step S246). When the last PDU transmission time T_psnd is equal to or smaller than the present PDU transmission time T_nsnd (No at step S246), the loss detecting unit 147 sets the clock high-order bit information up_clk_s_l acquired at step S241 as second high-order bits for loss detection (step S247). On the other hand, when the last PDU transmission time T_psnd is larger than the present PDU transmission time T_nsnd (Yes at step S246), the loss detecting unit 147 sets, as second high-order bits for loss detection, high-order bit information obtained by decrementing the clock high-order bit information up_clk_s_l acquired at step S241 (step S248) by one.

Thereafter, the loss detecting unit 147 generates the 48-bit last PDU transmission time T_psnd_48 in which high-order 32 bits are set as the second high-order bits for loss detection set at step S247 or S248 and low-order 16 bits are set as the last PDU transmission time T_psnd (step S249).

Subsequently, the loss detecting unit 147 generates a check code from the first high-order bits for loss detection set at step S243 or S244 and a header section and a data section of a received PDU (step S250). The loss detecting unit 147 determines whether the calculated check code is equal to a value stored in a trailer section of the received PDU (step S251). When the check code and the value do not coincide with each other (step S251), the loss detecting unit 147 determines that abnormality has occurred. The processing ends. When the check code and the value are equal (Yes at step S251), the processing returns to the processing shown in FIG. 15.

Referring back to FIG. 15, the loss detecting unit 147 determines whether a difference between the 48-bit present PDU transmission time T_nsnd_48 and the 48-bits last PDU transmission time T_psnd_48 is smaller than the loss evaluation time trns_interval (step S226). As a result of the determination, when the condition is not satisfied (No at step S226), the loss detecting unit 147 determines that there is a loss (step S227) and performs processing for, for example, disconnecting the master station 1. The processing ends. When the condition is satisfied (Yes at step S226), the loss detecting unit 147 determines that there is no loss (step S228). The loss detecting unit 147 stores the present PDU transmission time T_nsnd in the time-stamp storing unit 144 as the last PDU transmission time T_psnd (step S229). The processing returns to S223.

Loss Detection Processing by the Slave Station 2

The loss detection processing in the slave station 2 is basically the same as the loss detection processing in the master station 1. However, differences from the loss detection processing in the master station 1 are explained below. At step S221, a RefreshReady request has been received. At step S223, it is determined whether a Refresh request, a RefreshMO request, or a RefreshGO request has been received.

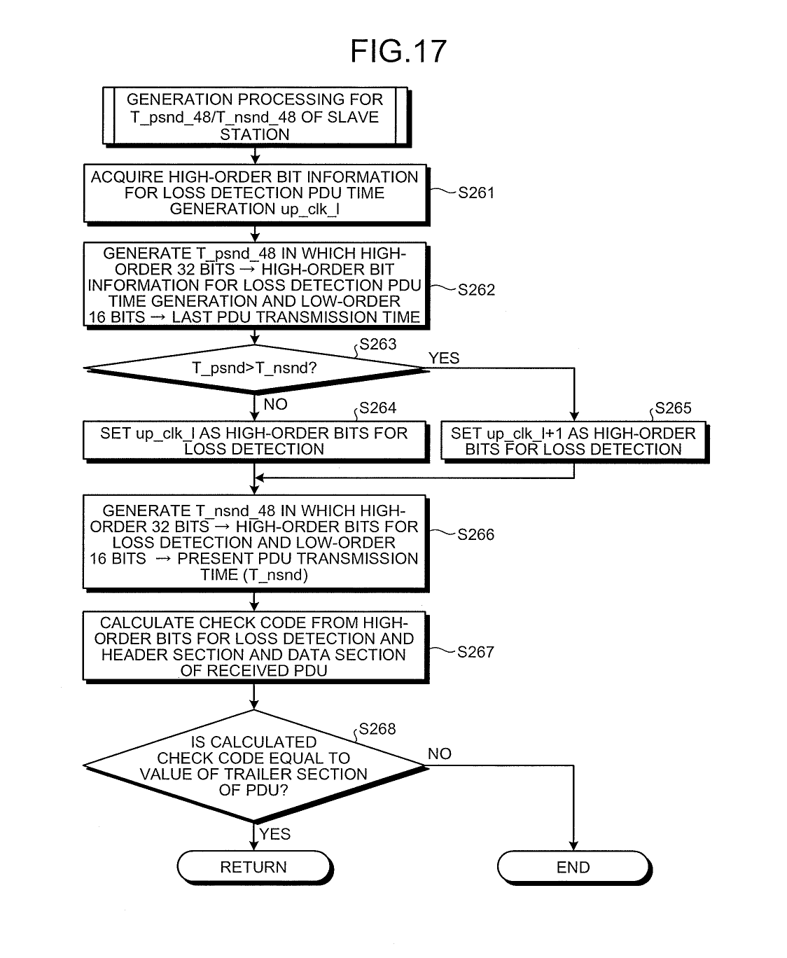

The generation processing for the 48-bit present PDU transmission time T_nsnd_48 and the 48-bit last PDU transmission time T_psnd_48 at step S225 is different from the generation processing performed in the master station 1. FIG. 17 is a flowchart for explaining an example of a procedure of the generation processing for a 48-bit PDU transmission time and a 48-bit PDU reception time by the slave station.

First, the loss detecting unit 248 of the slave station 2 acquires the high-order bit information for loss detection PDU time generation up_clk_l from the time-stamp storing unit 245 (step S261). Subsequently, the loss detecting unit 248 generates the 48-bit last PDU transmission time T_psnd_48 in which high-order 32 bits are set as high-order bit information for loss detection PDU time generation and low-order 16 bits are set as the last PDU transmission time T_psnd (step S262).

Thereafter, the loss detecting unit 248 determines whether the last PDU transmission time T_psnd is larger than the present PDU transmission time T_nsnd (step S263). When the last PDU transmission time T_psnd is equal to or smaller than the present PDU transmission time T_nsnd (No at step S263), the loss detecting unit 248 sets the high-order bit information for loss detection PDU time generation up_clk_l as high-order bits for loss detection (step S264). On the other hand, when the last PDU transmission time T_psnd is larger than the present PDU transmission time T_nsnd (Yes at step S263), the loss detecting unit 248 sets, as high-order bit for loss detection, high-order bit information obtained by incrementing the high-order bit information for loss detection PDU time generation up_clk_l by one (step S265). The loss detecting unit 248 stores up_clk_l+1 obtained at step S265 in the time-stamp storing unit 245 as new high-order bit information for loss detection PDU time generation up_clk_l.

Subsequently, the loss detecting unit 248 generates the 48-bit present PDU transmission time T_nsnd_48 in which high-order 32 bits are set as the high-order bits for loss detection set at step S264 or S265 and low-order 16 bits are set as the present PDU transmission time T_nsnd (step S266). Thereafter, the loss detecting unit 248 calculates a check code from the set high-order bit for loss detection and a header section and a data section of a received PDU (step S267). The loss detecting unit 248 determines whether the calculated check code is equal to a value stored in a trailer section of the received PDU (step S277). When the check code and the value do not coincide with each other (step S277), the loss detecting unit 248 determines that abnormality has occurred. The processing ends. When the check code and the value are equal (Yes at step S277), the processing returns to the processing shown in FIG. 12.

In the example explained above, the clock has the 48-bit width and only 16 bits can be stored in the TS of the PDU. However, the bit width of the clock can be other values and the number of bits stored in the TS of the PDU can be other values.

According to the second embodiment, in the TS and the OBL in which the time stamp of the PDU is stored, the low-order bits of a size fit in the regions of the TS and the OBL are stored. The master station 1 including the clock 11 set as a reference notifies the slave station 2 of the high-order bits of the clock when connection is established. Consequently, there is an effect that, even when the size of the TS of the PDU is limited to be smaller than the clock width, it is possible to perform the delay and loss detection and the calculation processing for a clock offset between the master station 1 and the slave station 2. A part of the clock included in the node only has to be included in the PDU. Therefore, there is also an effect that it is possible to reduce the size of the PDU.

### INDUSTRIAL APPLICABILITY

As explained above, the communication apparatus according to the present invention is useful as a communication device used in a system that periodically transmits and receives data.

### REFERENCE SIGNS LIST

1 node, master station
2 node, slave station
3 transmission line
11, 21 clocks
12, 22 transmission-data storing units
13, 23 reception-data storing units
14 master-delay/loss detecting unit
15, 25 frame transmitting units
16, 26 frame receiving units
24 slave-delay/loss detecting unit
141 connection-establishment requesting unit
142, 243 time-stamp generating units
143, 244 frame processing units
144, 245 time-stamp storing units
145, 247 one-way-delay detecting unit
146 round-trip-delay detecting unit
147, 248 loss detecting unit
241 connection-establishment responding unit
242 clock-offset storing unit
246 clock-offset calculating unit

1. A communication apparatus that performs periodical communication with another communication apparatus connected via a transmission line, the communication apparatus comprising:
a clock configured to measure time;
a communicating unit configured to transmit and receive a communication frame;
a time-stamp generating unit configured to generate a time stamp using the clock during transmission or during reception of the communication frame transmitted and received by the own communication apparatus;
a transmission-data storing unit configured to store periodical transmission data stored in the periodically-transmitted communication frame;
a reception-data storing unit configured to store the periodical transmission data in the periodically-received communication frame;
a frame processing unit configured to generate a refresh instruction frame including a data refresh instruction to the other communication apparatus, the periodical transmission data in the transmission-data storing unit, and a frame transmission time, which is a time stamp of transmission timing, acquired from the time-stamp generating unit and store, upon receiving a refresh instruction frame from the other communication apparatus, periodical transmission data included in the refresh instruction frame in the reception-data storing unit; and
a one-way-delay detecting unit configured to determine, upon receiving the refresh instruction frame, whether a next refresh instruction frame is received within a first delay allowable time after the refresh instruction frame is received last time and determine, when the next refresh instruction frame is received within the first delay allowable time, according to whether a transmission time of the refresh instruction frame from the other communication apparatus to the own apparatus is within a second delay allowable time, whether a delay has occurred in a communication frame transmitted from the other communication apparatus.

2. The communication apparatus according to claim 1, wherein the one-way-delay detecting unit uses, as the transmission time, a difference between a frame reception time acquired from the time-stamp generating unit at the reception time of the refresh instruction frame and the frame transmission time stored in the refresh instruction frame.

3. The communication apparatus according to claim 1, further comprising a round-trip-delay detecting unit configured to transmit a request frame to the other communication apparatus at time other than a periodical communication time and determine that a delay occurs when a response frame corresponding to the request frame is not received within a round-trip delay allowable time after the request frame is transmitted.

4. The communication apparatus according to claim 1, further comprising a loss detecting unit configured to acquire, upon receiving the refresh instruction frame, a present frame reception time from the time-stamp generating unit, compare a difference between the present frame reception time and a last frame reception time acquired from the time-stamp generating unit when the refresh instruction frame was received last time with a loss evaluation time indicating a loss of a communication frame, and determine a loss of the communication frame.

5. (canceled)

6. The communication apparatus according to claim 1, wherein the frame processing unit further has a function of transmitting, at a predetermined interval from a start of the periodical communication, the refresh instruction frame including a measurement instruction for a clock offset, and transmitting, upon receiving a response frame to the refresh instruction frame including the measurement instruction, the refresh instruction frame including a calculation instruction for a clock offset and a frame reception time indicating reception timing of the response frame.

7. The communication apparatus according to claim 1, wherein, when a region for storing the frame transmission time in the communication frame is “a” bits and width of the clock is “b” bits (>a),
the frame processing unit has a function of storing high-order (b-a) bits of the clock as high-order bit information when connection to the other communication apparatus is established and transmitting a communication frame including the high-order bit information when connection establishment is requested and a function of generating, during the periodical communication, a refresh instruction frame in which a low-order “a” bits of a time stamp obtained from the time-stamp generating unit is stored in a region where the frame transmission time is stored, and
the one-way-delay detecting unit sets a value of the frame transmission time in the refresh instruction frame as a value of the “b” bits using the high-order bit information and performs one-way delay detection.

8. The communication apparatus according to claim 4, wherein, when a region for storing the frame transmission time in the communication frame is “a” bits and width of the clock is “b” bits (>a),
the frame processing unit has a function of storing high-order (b-a) bits of the clock as high-order bit information when connection to the other communication apparatus is established and transmitting a communication frame including the high-order bit information when connection establishment is requested and a function of generating, during the periodical communication, a refresh instruction frame in which a low-order “a” bits of a time stamp obtained from the time-stamp generating unit is stored in a region where the frame transmission time is stored, and
the loss detecting unit sets a value of the frame transmission time in the refresh instruction frame as a value of the “b” bits using the high-order bit information and performs loss detection for the refresh instruction frame.

9. The communication apparatus according to claim 7, wherein the frame processing unit has a function of generating, when the refresh instruction frame is transmitted, a check code from the high-order (b-a) bits of the frame transmission time, a header section of the refresh instruction frame, and a data section in which the transmission data is stored and includes the check code in the refresh instruction frame and a function of correcting, when the refresh instruction frame is received, the high-order bit information based on a size relation between low-order “a” bits of a reception time in the own apparatus of the refresh instruction frame and the frame transmission time of “a” bits in the refresh instruction frame, generating a check code from the corrected high-order bit information and the header section and the data section of the received communication frame, and determining whether the check code coincides with a check code in the received refresh instruction frame.

10. The communication apparatus according to claim 1, further comprising a clock-offset storing unit configured to store a clock offset, which is an offset time of the clock of the own apparatus with respect to a clock included in the other communication apparatus, wherein
the time-stamp generating unit generates, when the refresh instruction frame transmitted by the own communication apparatus is transmitted or received, a time stamp obtained by correcting time obtained from the clock with the clock offset.

11. The communication apparatus according to claim 10, further comprising a loss detecting unit configured to acquire, when the refresh instruction frame is received, a present frame reception time from the time-stamp generating unit, compare a difference between the present frame reception time and a last frame reception time acquired from the time-stamp generating unit when the refresh instruction frame was received last time with a loss evaluation time indicating a loss of a communication frame, and determine a loss of the communication frame.

12. (canceled)

13. The communication apparatus according to claim 10, further comprising a clock-offset calculating unit configured to store, when the refresh instruction frame including a measurement instruction for a clock offset is received from the other communication apparatus, the frame transmission time included in the refresh instruction frame including the measurement instruction as a master transmission time, store reception timing of the refresh instruction frame including the measurement instruction as a slave reception time, and store transmission timing of a response frame to the refresh instruction frame including the measurement instruction as a slave transmission time and store, when the refresh instruction frame including a calculation instruction for a clock offset is received from the other communication apparatus, a frame reception time indicating reception timing of the response frame stored in the refresh instruction frame including the calculation instruction as a master reception time and calculate the clock offset using the master transmission time, the slave reception time, the slave transmission time, and the master reception time.

14. The communication apparatus according to claim 13, wherein, when the master transmission time is represented as Tm_snd, the slave reception time is represented as Ts_rcv, the slave transmission time is represented as Ts_snd, and the master reception time is represented as Tm_rcv, the clock-offset calculating unit calculates the clock offset ts_offset according to Formula (1) below:
ts_offset=[Tm_{—}rcv+Tm_{—}snd−(Ts_{—}rcv+Ts_{—}snd)]/2 (1)

15. The communication apparatus according to claim 10, wherein, when a region for storing the frame transmission time in the communication frame is “a” bits and width of the clock is “b” bits (>a),
the frame processing unit has a function of storing, when connection to the other communication apparatus is established, as high-order bit information, high-order (b-a) bits of a clock of the other communication apparatus stored in a communication frame transmitted from the other communication apparatus and a function of generating, during the periodical communication, a refresh instruction frame in which a low-order “a” bits of a time stamp obtained from the time-stamp generating unit is stored in a region where the frame transmission time is stored, and
the one-way-delay detecting unit sets a value of the frame transmission time in the refresh instruction frame as a value of the “b” bits using the high-order bit information and performs one-way delay detection.

16. The communication apparatus according to claim 11, wherein, when a region for storing the frame transmission time in the communication frame is “a” bits and width of the clock is “b” bits (>a),
the frame processing unit has a function of storing, when connection to the other communication apparatus is established, as high-order bit information, high-order (b-a) bits of a clock of the other communication apparatus stored in a communication frame transmitted from the other communication apparatus and a function of generating, during the periodical communication, a refresh instruction frame in which a low-order “a” bits of a time stamp obtained from the time-stamp generating unit is stored in a region where the frame transmission time is stored, and
the loss detecting unit sets a value of the frame transmission time in the refresh instruction frame as a value of the “b” bits using the high-order bit information and performs loss detection for the communication frame.

17. The communication apparatus according to claim 13, wherein, when a region for storing the frame transmission time in the communication frame is “a” bits and width of the clock is “b” bits (>a),
the frame processing unit has a function of storing, when connection to the other communication apparatus is established, as high-order bit information, high-order (b-a) bits of a clock of the other communication apparatus stored in a communication frame transmitted from the other communication apparatus and a function of generating, during the periodical communication, a refresh instruction frame in which a low-order “a” bits of a time stamp obtained from the time-stamp generating unit is stored in a region where the frame transmission time is stored, and
the offset calculating unit sets the master transmission time, the slave reception time, the slave transmission time, and the master reception time as a value of the “b” bits using the high-order bit information and performs calculation of the clock offset.

18. (canceled)

19. A delay detecting method by any one of two communication apparatuses connected via a transmission line in a communication system in which periodical communication is performed between the two communication apparatuses, the delay detecting method comprising:
a first timer starting step of starting a timer when the periodical communication is started;
a first one-way-delay determining step of determining whether a refresh instruction frame including a refresh instruction from another communication apparatus is received within a predetermined time from the start of the timer;
a frame-reception-time acquiring step of acquiring, when the refresh instruction frame is received at the first determining step, a frame reception time of reception timing of the refresh instruction frame;
a frame-transmission-time acquiring step of acquiring a frame transmission time, which is a transmission time of the refresh instruction frame by the other communication apparatus stored in the refresh instruction response frame;
a second one-way-delay determining step of determining presence or absence of delay occurrence using the frame reception time and the frame transmission time; and
a timer restarting step of restarting the timer after the second one-way-delay determining step.

20. The delay detecting method according to claim 19, further comprising:
a second timer starting step of transmitting a request frame to the other communication apparatus and starting the timer before the periodical communication is performed; and
a round-trip-delay determining step of determining whether a response frame to the request frame is received from the communication apparatus within a predetermined time.

21. The delay detecting method according to claim 19 further comprising:
a last-frame-transmission-time acquiring step of acquiring, upon receiving a communication frame indicating refresh preparation completion from the other communication apparatus, as a last frame transmission time, a frame transmission time of the communication frame stored in the communication frame;
a present-frame-transmission-time acquiring step of acquiring, upon receiving the refresh instruction frame from the other communication apparatus next, as a present frame transmission time, a frame transmission time of the refresh instruction frame stored in the refresh instruction frame; and
determining whether a difference between the present frame transmission time and the last frame transmission time is within a loss evaluation time in which a loss of the communication frame is not determined to have occurred.

22. The delay detecting method according to claim 21, further comprising a last-frame-transmission-time resetting step of setting, when it is determined in the frame-loss determining step that a loss of the communication frame has not occurred, a value of the present frame transmission time as the last frame transmission time, wherein
processing from the present-frame-transmission-time acquiring step is repeatedly executed.

23. The delay detecting method according to claim 19, further comprising:
a clock-offset-measurement instructing step in which a master station, which is a communication apparatus including a reference clock of the two communication apparatus, transmits, when timing for calculation of a clock offset that is a shift of time of a clock of a slave station, which is the other communication apparatus, with respect to the clock of the master station comes, to the slave station, a first refresh instruction request frame obtained by including a measurement instruction for the clock offset in a periodically-transmitted refresh instruction frame including a data refresh instruction to the slave station, periodical transmission data to be periodically transmitted, and a frame transmission time of the frame;
a request-frame-reception processing step in which, upon receiving the first refresh instruction request frame, the slave station stores, as a master transmission time, the frame transmission time included in the refresh instruction request frame and stores, as a slave reception time, reception timing of the first refresh instruction request frame;
a response-frame transmitting step in which the slave station transmits, to the master station, a refresh instruction response frame obtained by imparting a function of a response to the first refresh instruction request frame to a periodically-transmitted refresh instruction frame including a data refresh instruction to the master station and a periodical transmission data and stores a transmission time of the refresh instruction response frame as a slave transmission time;
a clock-offset-calculation instructing step in which, upon receiving the refresh instruction response frame, the master station acquires a reception time of the refresh instruction response frame as a master reception time and transmits, to the slave station, a second refresh instruction request frame obtained by including a calculation instruction for the clock offset in a periodically-transmitted refresh instruction frame including a data refresh instruction to the slave station, a periodically-transmitted periodical transmission data, and the master reception time; and
a clock-offset calculating step in which, upon receiving the second refresh instruction request frame, the slave station calculates, after acquiring the slave reception time, the clock offset of the slave station using the master transmission time, the slave reception time, the slave transmission time, and the master reception time.
